(19) United States
(12) Patent Application Publication
(10) Pub. No.: US 2013/0214881 A1
(43) Pub. Date: Aug. 22, 2013

(54) RELAY

(71) Applicants: Shinsuke Ito, Konan-shi (JP); Youichi Hattori, Nagoya-shi (JP); Norihiko Nadanami, Inuyama-shi (JP); Ryuji Inoue, Tajimi-shi (JP); Takeshi Mitsuoka, Kohnan-shi (JP); Takio Kojima, Ichinomiya-shi (JP)

(72) Inventors: Shinsuke Ito, Konan-shi (JP); Youichi Hattori, Nagoya-shi (JP); Norihiko Nadanami, Inuyama-shi (JP); Ryuji Inoue, Tajimi-shi (JP); Takeshi Mitsuoka, Kohnan-shi (JP); Takio Kojima, Ichinomiya-shi (JP)

(73) Assignee: NGK SPARK PLUG CO., LTD., Nagoya-shi, Aichi (JP)

(21) Appl. No.: 13/882,646

(22) PCT Filed: Oct. 31, 2011
(86) PCT No.: PCT/JP2011/006099

§ 371 Date: Apr. 30, 2013

(30) Foreign Application Priority Data
Nov. 1, 2010 (JP) 2010-245522
Jan. 17, 2011 (JP) 2011-006553

(51) Int. Cl. H01H 33/18

(52) U.S. Cl. CPC H01H 33/18
USPC 335/127

(57) ABSTRACT

A relay includes a pair of fixed terminals arranged to respectively have fixed contacts, a movable contact member arranged to have a pair of movable contacts, a driving structure operated to move the movable contact member and a magnet arranged to extinguish an arc. The movable contact member has a center section located between the pair of movable contacts. The magnet is placed on at least one of a first side and a second side that face each other across a predetermined face including the movable contact member and the pair of fixed terminals electrically connected by the movable contact member. The magnet is arranged to have a magnitude relation that a center area where the center section is located has a lower magnetic flux density than movable contact portions where the pair of movable contacts are located.

### TECHNICAL FIELD

The present invention relates to a relay.

### BACKGROUND ART

A known structure of a relay includes a pair of fixed contacts, a movable contact member having a pair of movable contacts opposed to the pair of fixed contacts, and a movable iron core and a coil configured to move the movable contact member (for example, PTL1). In the relay of this structure, an arc discharge (hereinafter simply referred to as “arc”) may be generated between the movable contact and the fixed contact in the course of opening or closing the contacts. Permanent magnets are thus provided to extend and extinguish the generated arc by Lorentz force.

### CITATION LIST

### Patent Literatures

PTL1: JP H09-320437A

### SUMMARY OF INVENTION

### Technical Problem

According to the locations of the permanent magnets, however, the Lorentz force may be applied to the electric current flowing between the pair of movable contacts in the direction of moving the movable contact member away from the pair of fixed contacts in the state that the coil is energized (in the ON state of the relay). Such action of the Lorentz force may interfere with maintaining the stable contact between the movable contacts and the fixed contacts in the state that the coil is energized to bring the movable contacts into contact with the fixed contacts. Especially when high current (for example, 5000 A or higher) flows in a system including such a relay, there is a possibility that the stable contact between the contacts is not maintained.

An arc generated between the contacts in the course of separating the movable contacts from the fixed contacts may cause various troubles or problems in the relay. For example, the arc may scatter the particulates of the component part of the fixed contact or the movable contact member to establish electrical continuity between the fixed contacts. The arc may also cause the joint area of the respective component parts to be molten. Electric arc may increase the pressure of an internal space and damage at least part of the component parts that form the internal space.

Firstly, the object of the invention is to provide a technique that stably maintains the contact between contacts in the relay. Secondly, the object of the invention is to provide a technique that reduces the occurrence of trouble caused by electric arc in the relay.

The entire contents of the applications JP 2010-245522A and JP 2011-6553A are incorporated herein by reference.

### Solution to Problem

In order to solve at least part of the above problems, the invention provides various aspects and embodiments described below.

### First Aspect:

A relay, comprising:

a pair of fixed terminals arranged to respectively have fixed contacts;

a movable contact member arranged to have a pair of movable contacts that are correspondingly opposed to the respective fixed contacts of the pair of fixed terminals;

a driving structure operated to move the movable contact member, such that the respective movable contacts come into contact with the corresponding fixed contacts; and

a magnet arranged to extinguish an arc generated between each pair of the fixed contact and the movable contact facing each other, wherein

the movable contact member has a center section located between the pair of movable contacts,

the magnet is placed on at least one of a first side and a second side that face each other across a predetermined face including the movable contact member and the pair of fixed terminals electrically connected by the movable contact member, and

the magnet is arranged to have a magnitude relation that a center area where the center section is located has a lower magnetic flux density than movable contact portions where the pair of movable contacts are located.

In the relay according to the first aspect, the magnet is arranged to have the magnitude relation that the center area where the center section has a lower magnetic flux density than the movable contact portions where the pair of movable contacts are located. This reduces the Lorentz force acting in a direction of moving the movable contact member away from the pair of fixed contacts, compared with the magnitude relation that the magnetic flux density of the center area is equal to the magnetic flux density of the movable contact portions. The magnetic flux density of the movable contact portions is higher than the magnetic flux density of the center area. This reduces the Lorentz force acting in the direction of moving the movable contact member away from the pair of fixed contacts, while keeping the Lorentz force acting on arc current generated in the course of opening or closing each pair of the fixed contact and the movable contact. This stably maintains the contact between the pair of fixed contacts and the movable contact member in the ON state of the relay (i.e., the state that the driving structure is operated).

### Second Aspect:

The relay according to the first aspect, wherein

the magnet placed on at least one of the first side and the second side is a single magnet. The magnet in the relay accordingly to the second aspect has the higher magnetic flux density than split magnets of the same thickness.

### Third Aspect:

The relay according to either one of the first aspect and the second aspect, wherein

the movable contact member has a pair of extended sections that are located between the center section and the pair of movable contacts and are extended in a direction including a moving direction component of the movable contact member.

In the relay according to the third aspect, the presence of the extended sections between the center section and the pair of movable contacts enables the center section to be located at the position further away from the pair of fixed contacts than the pair of movable contacts. This causes the center area to have the lower magnetic flux density than the movable contact portions and thereby stably maintains the contact between the pair of fixed contacts and the movable contact member in the ON state of the relay.

### Fourth Aspect:

The relay according to the third aspect, wherein

in vertical projection of the relay onto a projection face that is parallel to the predetermined face, the pair of movable contacts are located at positions that are overlapped with the magnet, and at least part of the center section is located at a position that is not overlapped with the magnet.

In the relay according to the fourth aspect, the magnet is located at the position that does not overlap at least part of the center section. This arrangement causes the center area to have the lower magnetic flux density than the movable contact portions. This reduces the Lorentz force acting in the direction of moving the movable contact member away from the pair of fixed contacts and thereby more stably maintains the contact between the pair of fixed contacts and the movable contact member in the ON state of the relay.

### Fifth Aspect:

The relay according to either one of the third aspect and the fourth aspect, wherein

the movable contact member also has a pair of movable contact portions that are extended from the pair of extended sections to be closer to each other.

The relay according to the fifth aspect has the pair of movable contact portions extended from the extended sections to be closer to each other. This structure enables the Lorentz force to act on the movable contact member in the direction of moving the pair of movable contact portions closer to the fixed contacts by regulating the direction of the electric current flowing through the movable contact portions and the direction to locate the magnet. This more stably maintains the contact between the pair of fixed contacts and the movable contact member in the ON state of the relay.

### Sixth Aspect:

The relay according to either one of the first aspect and the second aspect, further comprising:

a magnetic shield located between the center section and the magnet.

The relay according to the sixth aspect has the magnetic shield placed between the center section and the magnet. This structure causes the center area to have the lower magnetic flux density than the movable contact portions. This stably maintains the contact between the pair of fixed contacts and the movable contact member in the ON state of the relay.

### Seventh Aspect:

The relay according to any one of the first claim to the sixth claim, further comprising:

a vessel configured to internally form an internal space and arranged to place the movable contact member and the respective fixed terminals therein, wherein

the vessel comprises:
one first vessel arranged to have insulating property and structured to have a bottom and two chambers formed as part of the internal space corresponding to the pair of fixed terminals, wherein the pair of fixed terminals pass through the bottom of the first vessel and are attached to the first vessel, such that the pair of fixed contacts of the fixed terminals are placed inside of the first vessel and portions of remaining parts of the fixed terminals are placed outside of the first vessel; and
a second vessel joined with the first vessel to form, in combination with the respective fixed terminals and the first vessel, the internal space, wherein

the first vessel has a partition wall member that is extended from the bottom to a position further away from the bottom than at least a position where the respective fixed contacts are located with respect to a moving direction of the movable contact member, the partition wall member parting the two chambers from each other, and

the respective fixed contacts are placed inside the respective chambers in the internal space.

In the relay according to the seventh aspect, the first vessel has the partition wall member formed to part the two chambers from each other, such that the pair of fixed contacts are respectively placed inside the two chambers. Even when electric arc scatters the particulates of the component part of the fixed terminal, this structure enables the partition wall member of the first vessel to work as the barrier and thereby reduces the possibility that the particulates are accumulated to establish electrical continuity between the fixed terminals. This accordingly reduces the possibility that electrical continuity is established between the fixed terminals in the OFF state of the relay (i.e., the state that the driving structure is not operated).

### Eighth Aspect:

The relay according to the seventh aspect, wherein

the partition wall member is extended from the bottom to a position further away from the bottom than at least a position where the respective movable contacts are located, with respect to the moving direction of the movable contact member, and

the respective movable contacts are placed inside the respective chambers in the internal space.

In the relay according to the eighth aspect, the respective movable contacts are also placed inside the respective chambers. Even when electric arc scatters the particulates of the component part of the movable contact member including the movable contacts, this structure enables the partition wall member of the first vessel to work as the barrier and thereby more effectively reduces the possibility that the particulates are accumulated to establish electrical continuity between the fixed terminals.

### Ninth Aspect:

A relay, comprising:

a pair of fixed terminals arranged to respectively have fixed contacts;

a movable contact member arranged to have a pair of movable contacts that are correspondingly opposed to the respective fixed contacts of the pair of fixed terminals;

a driving structure operated to move the movable contact member, such that the respective movable contacts come into contact with the corresponding fixed contacts;

a magnet arranged to extinguish an arc generated between each pair of the fixed contact and the movable contact facing each other; and

a vessel configured to internally form an internal space and arranged to place the movable contact member and the fixed contacts therein, wherein

the movable contact member has a center section located between the pair of movable contacts,

the magnet is placed on at least one of a first side and a second side that face each other across a predetermined face including the movable contact member and the pair of fixed terminals electrically connected by the movable contact member,

the magnet is arranged to have a magnitude relation that a center area where the center section is located has a lower magnetic flux density than movable contact portions where the pair of movable contacts are located, and

the vessel comprises:
two first vessels provided corresponding to the respective fixed terminals and arranged to place the respective fixed contacts therein; and
a second vessel joined with the two first vessels to form, in combination with the respective fixed terminals and the respective first vessels, the internal space.

In the relay according to the ninth aspect, the magnet is arranged to have the magnitude relation that the center area where the center section has a lower magnetic flux density than the movable contact portions where the pair of movable contacts are located. This reduces the Lorentz force acting in a direction of moving the movable contact member away from the pair of fixed contacts, compared with the magnitude relation that the magnetic flux density of the center area is equal to the magnetic flux density of the movable contact portions. The magnetic flux density of the movable contact portions is higher than the magnetic flux density of the center area. This reduces the Lorentz force acting in the direction of moving the movable contact member away from the pair of fixed contacts, while keeping the Lorentz force acting on arc current generated in the course of opening or closing each pair of the fixed contact and the movable contact. This stably maintains the contact between the pair of fixed contacts and the movable contact member in the ON state of the relay. The first vessels are provided corresponding to the respective fixed terminals, and the respective fixed contacts are placed inside the respective first vessels. Even when the pair of arcs are extended to be closer to each other, this structure enables the respective first vessels to work as the barriers and thereby reduces the possibility that the pair of arcs collide with each other to cause a short circuit.

### Tenth Aspect:

The relay according to the ninth aspect, wherein

the respective movable contacts are placed inside the respective first vessels in the internal space.

In the relay according to the tenth aspect, the respective movable contacts are placed inside the respective first vessels. This arrangement more effectively reduces the possibility that the pair of arcs collide with each other, even when the pair of arcs are extended to be closer to each other.

### Eleventh Aspect:

The relay according to any one of the first aspect to the tenth aspect, wherein

the magnet is placed on both the first side and second side.

The relay according to the eleventh aspect has the greater Lorentz force acting on the arc currents than the arrangement where the magnet is placed only one of the first side and the second side. This arrangement thus more effectively accelerates extinction of the generated arcs.

### Twelfth Aspect:

A relay, comprising:

a pair of fixed terminals arranged to respectively have fixed contacts;

a movable contact member arranged to have a pair of movable contacts that are correspondingly opposed to the respective fixed contacts of the pair of fixed terminals;

a driving structure operated to move the movable contact member, such that the respective movable contacts come into contact with the corresponding fixed contacts; and

a magnet arranged to extinguish an arc generated between each pair of the fixed contact and the movable contact facing each other,

the relay being applied to a system including a power source and a load, wherein

the magnet is placed on at least one of a first side and a second side that face each other across a predetermined face including the movable contact member and the pair of fixed terminals electrically connected by the movable contact member and is arranged to apply Lorentz force to electric current flowing through the movable contact member in a direction of moving the movable contact member closer to the opposed fixed contacts, when electric current flows in the relay during supply of electric power from the power source to the load.

In the relay according to the twelfth aspect, the magnet produces the Lorentz force in the direction of moving the movable contact member closer to the opposed fixed contacts in the state that the movable contacts and the opposed fixed contacts are in contact with each other. This stably maintains the contact between the movable contacts and the fixed contacts opposed to each other. Especially in the case where high current flows in the relay, this structure maintains the stable contact between the movable contacts and the fixed contacts opposed to each other. The technical matters described in either of the second and the third aspects may be incorporated into the relay according to the twelfth aspect. For example, the technical matter relating to the shape of the movable contact member described in the third aspect may be incorporated in the twelfth aspect. In the twelfth aspect, the magnets are preferably placed on both of the first side and the second side. This applies the large Lorentz force to the electric current flowing through the movable contact member and thus more stably maintains the contact between the movable contacts and the fixed contacts opposed to each other.

The present invention may be implemented by any of various applications, for example, the relay, a method of manufacturing the relay and a moving body, such as vehicle or ship, equipped with the relay.

### BRIEF DESCRIPTION OF DRAWINGS

FIG. 1 is a diagram illustrating an electric circuit 1 including a relay 5 according to a first embodiment;

FIG. 2 is an appearance diagram of the relay 5;

FIG. 3A is a perspective view of a relay main unit and permanent magnets 800;

FIG. 3B is a diagram showing the relay main unit 6 and the permanent magnets 800 viewed from the positive Z-axis direction;

FIG. 4 is a 3-3 cross sectional view of the relay main unit 6 shown in FIG. 3B;

FIG. 5 is a perspective view of the relay main unit 6 shown in FIG. 4;

FIG. 6A is a diagram illustrating part of the cross section shown in FIG. 4;

FIG. 6B is a diagram illustrating the permanent magnets 800;

FIG. 7 is a 5-5 cross sectional view of the relay 5 shown in FIG. 3B;

FIG. 8A is a diagram equivalent to the 3-3 cross sectional view of FIG. 3B;

FIG. 8B is a diagram showing the positional relationship between permanent magnets 800 and a magnetic shield 850;

FIG. 9 is a diagram illustrating a relay 5b according to a third embodiment;

FIG. 10 is a perspective view of a relay main unit 6b shown in FIG. 9;

FIG. 11A is a first appearance diagram of a relay 5d according to a fourth embodiment;

FIG. 11B is a second appearance diagram of the relay 5d;

FIG. 12A is a 6-6 cross sectional view of FIG. 11B;

FIG. 12B is a diagram illustrating permanent magnets 800d;

FIG. 13 is an appearance perspective view of a relay main unit 6d shown in FIG. 12;

FIG. 14A is an appearance perspective view of a third vessel 34d;

FIG. 14B is an appearance perspective view of a cover vessel member 340;

FIG. 14C is an appearance perspective view of a lower vessel member 360;

FIG. 15A is a perspective view illustrating the third vessel 34d, a rod 60 and a movable contact member 50;

FIG. 15B is a perspective view illustrating the third vessel 34d, the rod 60 and the movable contact member 50;

FIG. 16 is a diagram illustrating a relay 5e according to a fifth embodiment;

FIG. 17 is a diagram illustrating a relay 5f according to a sixth embodiment;

FIG. 18 is a cross sectional view of a relay 5h according to a seventh embodiment;

FIG. 19 is an appearance perspective view of a relay 5i according to an eighth embodiment;

FIG. 20 is a cross sectional view of FIG. 19;

FIG. 21 is a diagram illustrating a relay 5g according to a second modification;

FIG. 22 is a diagram illustrating a relay 5ja according to Modification A;

FIG. 23 is a diagram illustrating a first variation of Modification A;

FIG. 24 is a diagram illustrating a second variation of Modification A;

FIG. 25 is a diagram illustrating a third variation of Modification A;

FIG. 26 is a diagram illustrating an auxiliary member 121;

FIG. 27 is a diagram illustrating a relay 5ka according to Modification B;

FIG. 28 is a diagram illustrating a first variation of Modification B;

FIG. 29 is a diagram illustrating a second variation of Modification B;

FIG. 30 is a diagram illustrating a movable contact member 50m; and

FIG. 31 is a diagram illustrating a movable contact member 50r.

### DESCRIPTION OF EMBODIMENTS

Embodiments of the invention are described in the following sequence:

A to H: Respective Embodiments

I: Modifications

### A. First Embodiment

A-1. General Structure of Relay

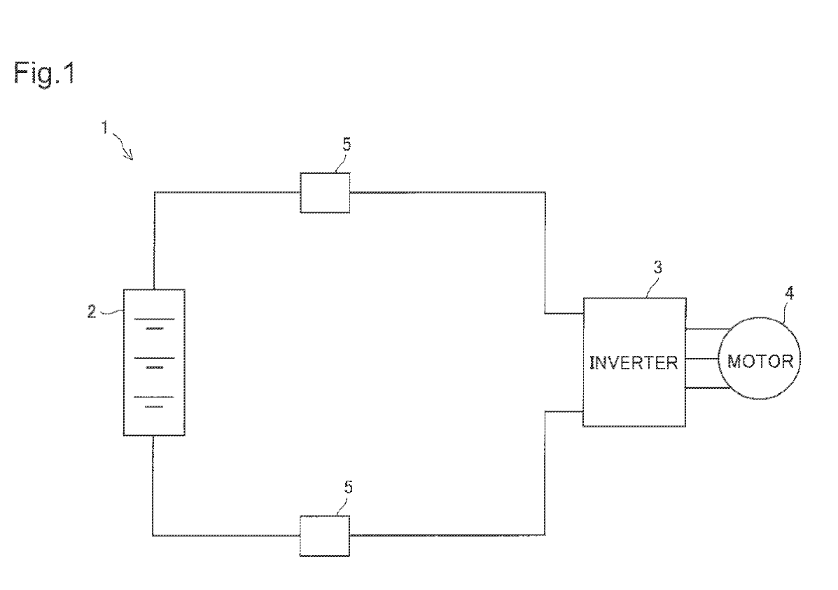

FIG. 1 is a diagram illustrating an electric circuit 1 including a relay 5 according to a first embodiment. The electric circuit 1 is mounted on, for example, a vehicle. The electric circuit 1 includes a DC power source 2, the relay 5, an inverter 3 and a motor 4. The inverter 3 converts the direct current of the DC power source 2 into alternating current. Supplying the alternating current converted by the inverter 3 to the motor 4 drives the motor 4. The driven motor 4 causes the vehicle to run. The relay 5 is located between the DC power source 2 and the inverter 3 to open and close the electric circuit 1.

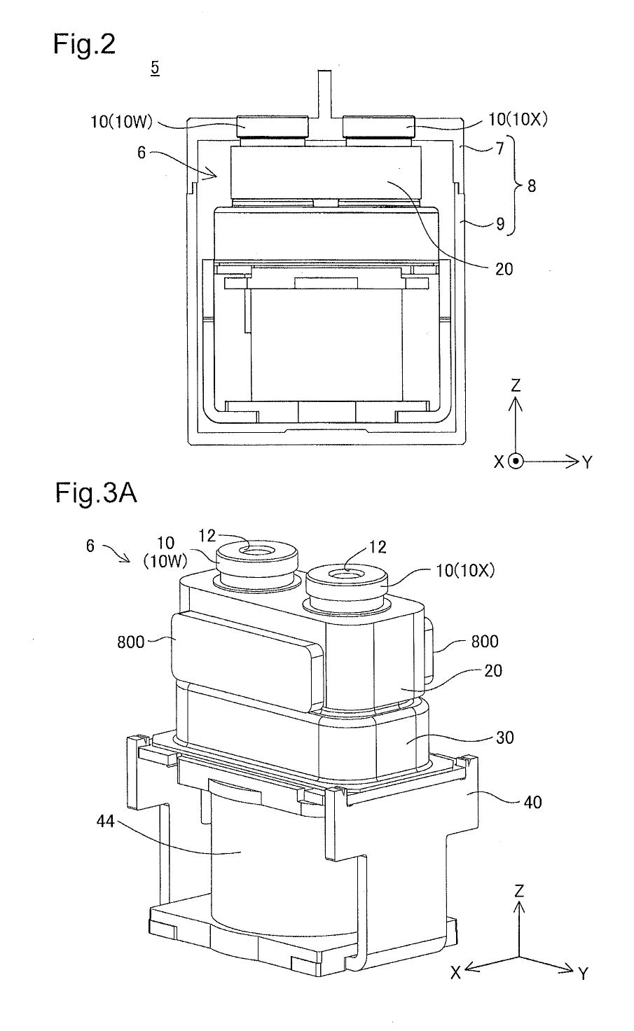

FIG. 2 is an appearance diagram of the relay 5. For the better understanding, a relay main unit 6 placed inside an outer casing 8 is also shown by the solid line in FIG. 2. In order to specify the directions, XYZ axes are shown in FIG. 2. The XYZ axes are shown in other drawings according to the requirements.

The relay 5 includes the relay main unit 6 and the outer casing 8 for protecting the relay main unit 6. The relay main unit 6 has a pair of fixed terminals 10. The pair of fixed terminals 10 are joined with a first vessel 20. The fixed terminal 10 has a connection port (not shown) for connecting the wiring of the electric circuit 1. The pair of fixed terminal 10 are electrically connected by a movable contact member described later, so that electric current (electric power) is supplied from the DC power source 2 to the motor 4 via the inverter 3. The outer casing 8 includes an upper case 7 and a lower case 9. The upper case 7 and the lower case 9 internally form a space to place the relay main unit 6 therein. The upper case 7 and the lower case are both made of resin material. The relay 5 has a pair of (two) permanent magnets (not shown) between the outer casing 8 and the relay main unit 6 and a vibration-isolating member (not shown). The magnetic flux of the permanent magnets extends the arc by the Lorentz force. This accelerates extinction of the arc. The vibration-isolating member may be an elastic member of, for example, silicone rubber. The presence of the vibration-isolating member improves the vibration resistance of the relay 5. During supply of electric current (electric power) from the DC power source 2 to the motor 4, one of the pair of fixed terminals 10 which the electric current flows in is called positive fixed terminal 10W, and the other which the electric current flows out is called negative fixed terminal 10X. The following describes the relay 5 during supply of electric current from the DC power source 2 to the motor 4.

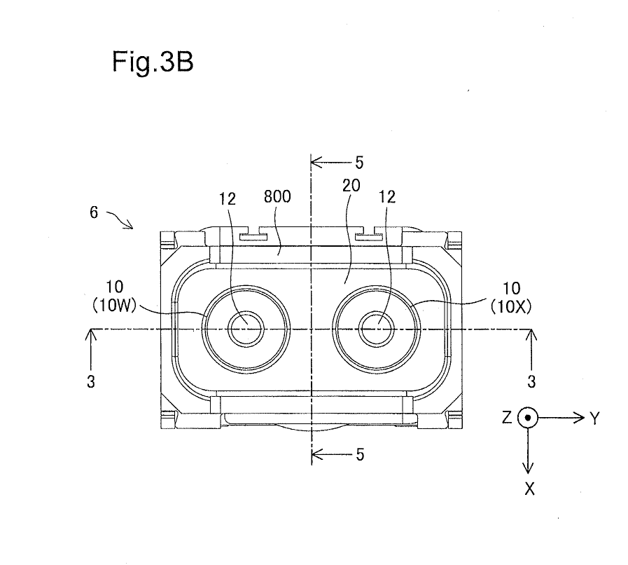

FIGS. 3A and 3B are diagrams illustrating the general structure of the relay 5. FIG. 3A is a perspective view of the relay main unit 6 and the permanent magnets 800. FIG. 3B is a diagram showing the relay main unit 6 and the permanent magnets 800 viewed from the positive Z-axis direction (directly above).

The relay 5 has two single permanent magnets 800 provided to extend and extinguish an arc. The two permanent magnets 800 are arranged along a direction where the pair of fixed terminals 10 face each other (Y-axis direction) across the pair of fixed terminals 10. Additionally the two permanent magnets 800 are arranged to have surfaces of different polarities faced each other across the pair of fixed terminals 10. The permanent magnet 800 has non-split, continuous plate-like shape. The details of the permanent magnets 800 will be described later. The fixed terminal 10 has the connection port 12 for connecting the wiring.

A-2. Detailed Structure of Relay

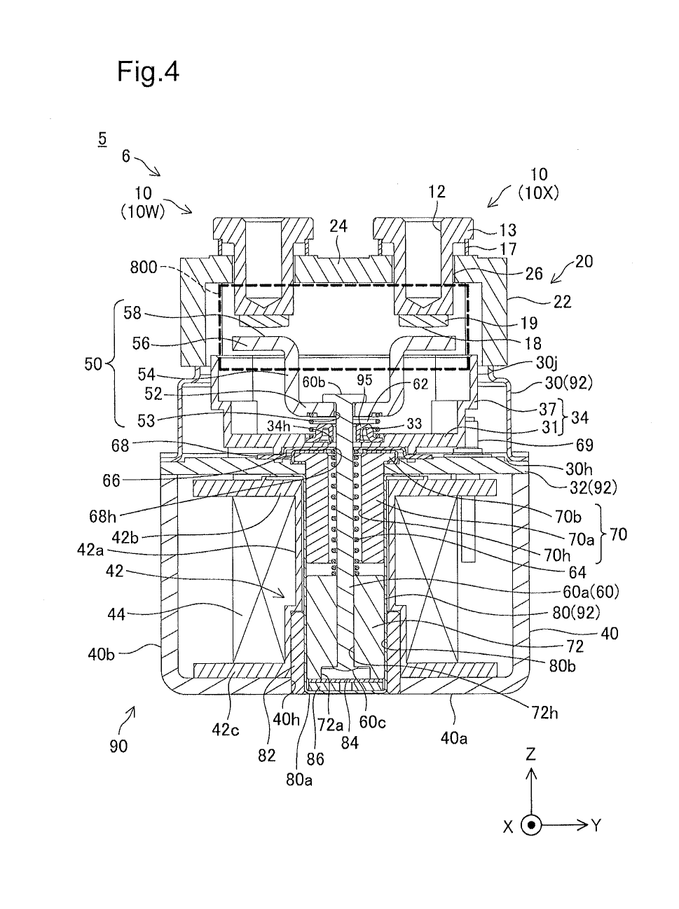

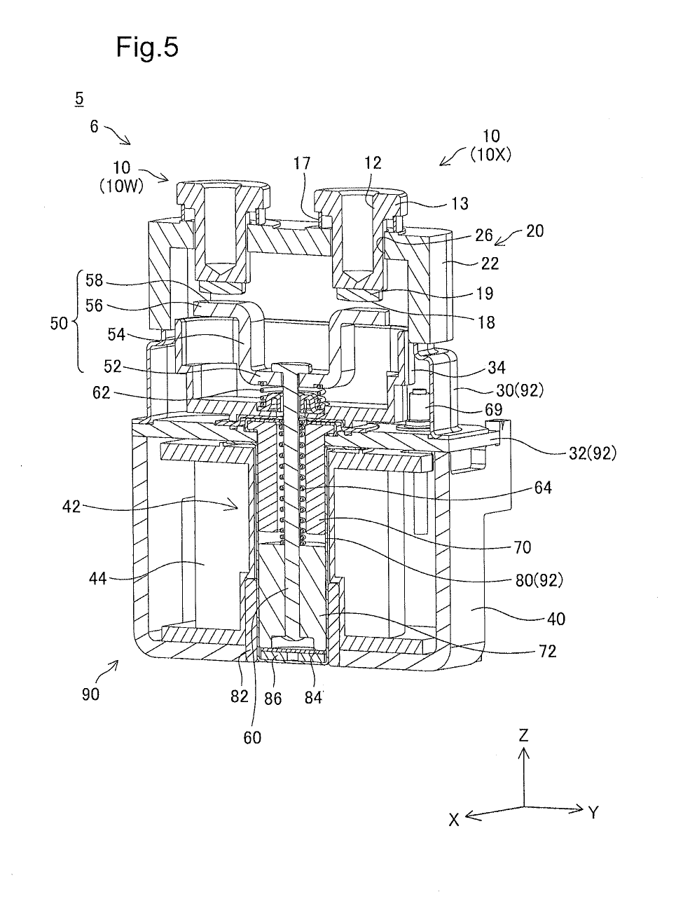

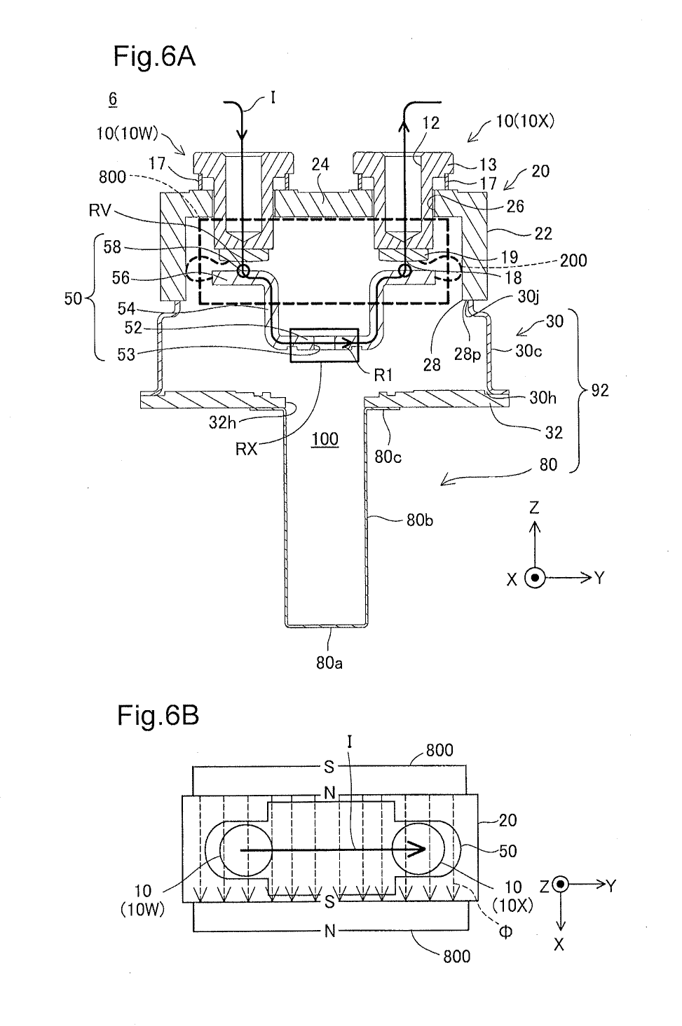

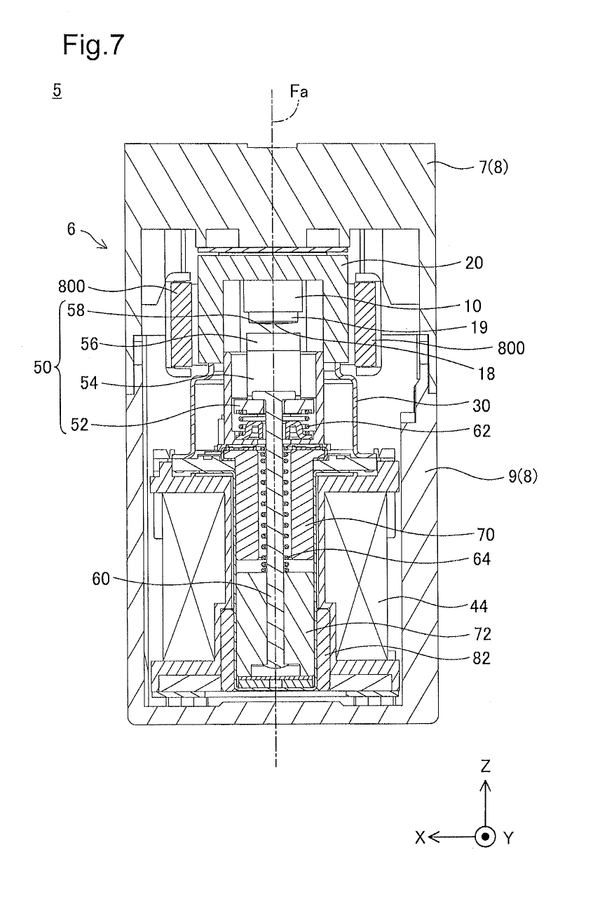

The following describes the detailed structure of the relay 5 with reference to FIGS. 4 to 7. FIG. 4 is a 3-3 cross sectional view of the relay main unit 6 shown in FIG. 3B. FIG. 5 is a perspective view of the relay main unit 6 shown in FIG. 4. FIGS. 6A and 6B are diagrams illustrating part of the structure of the relay 5. FIG. 6A is a diagram illustrating part of the cross section shown in FIG. 4. FIG. 6B is a diagram illustrating the permanent magnets 800 and is a view of the relay 5 viewed from the positive Z-axis direction. FIG. 7 is a 5-5 cross sectional view of the relay 5 shown in FIG. 3B including the outer casing 8 (upper case 7 and lower case 9) and the permanent magnets 800. For the purpose of clearly specifying the positions of permanent magnets 800, the outline of the permanent magnet 800 is shown by the dotted line in FIGS. 4 and 6A.

As shown in FIGS. 4 and 5, the relay main unit 6 includes the pair of (two) fixed terminal 10, a movable contact member 50, a driving structure 90, the first vessel 20 and a second vessel 92 (FIG. 6). In FIGS. 4 to 7, the Z-axis direction is the vertical direction, the positive Z-axis direction is the upward direction, and the negative Z-axis direction is the downward direction. The Y-axis direction is the horizontal direction.

The description first regards an air-tight space 100 formed in the relay main unit 6, the movable contact member 50 and the permanent magnets 800 mainly with reference to FIGS. 6A and 6B. As shown in FIGS. 6A and 6B, the air-tight space 100 is formed by the pair of fixed terminals 10, the first vessel 20 and the second vessel 92. The fixed terminals 10 are provided as members having electrical conductivity. The fixed terminals 10 are made of, for example, a copper-containing metal material. The fixed terminal 10 has a bottom and is formed in cylindrical shape. The fixed terminal 10 has a fixed contact area 19 at the bottom on one end (negative Z-axis direction side). The fixed contact area 19 may be made of the copper-containing metal material like the other parts of the fixed terminal 10 or may be made of a material having higher heat resistance (for example, tungsten) to protect from arc-induced damage. One face of the fixed contact area 19 opposed to the movable contact member 50 forms a fixed contact 18 that comes into contact with the movable contact member 50. A flange 13 extended outward in the radial direction is formed on the other end (positive Z-axis direction side) of the fixed terminal 10. The flange 13 is located outside of the first vessel 20.

The first vessel 20 is provided as a member having insulating properties. The first vessel 20 is made of a ceramic material, for example, alumina or zirconia and has excellent heat resistance. According to this embodiment, the first vessel 20 is made of alumina. The first vessel 20 has a side face member 22 forming the side face, a bottom 24 including upward protrusions corresponding to part of the fixed terminals 10 and an opening 28 formed on one end opposed to the bottom 24 (i.e., side where the second vessel 92 is located). The bottom 24 has two through holes 26 formed to allow insertion of the two fixed terminals 10. The flange 13 of each fixed terminal 10 is air-tightly joined with the outer surface (surface exposed on the outside) of the bottom 24 of the first vessel 20. More specifically, the fixed terminal 10 is joined with the first vessel 20 by the following structure. One side face of the outer surface of the flange 13 opposed to the bottom 24 of the first vessel 20 has a diaphragm 17 formed to protect the joint between the fixed terminal 10 and the first vessel 20 from damage. The diaphragm 17 is formed to relieve the stress generated at the joint due to the thermal expansion difference between the fixed terminal 10 and the first vessel 20 made of different materials. The diaphragm 17 is formed in cylindrical shape having the larger inner diameter than that of the through hole 26. The diaphragm 17 is made of, for example, an alloy like kovar and is bonded to the outer surface of the bottom 24 of the first vessel 20 by brazing. For example, silver solder may be used for brazing. When the diaphragm 17 is provided as a separate body from the fixed terminal 10, the diaphragm 17 is also brazed to the flange 13 of the fixed terminal 10. Alternatively the diaphragm 17 may be formed integrally with the fixed terminal 10.

The second vessel 92 includes an iron core case 80 having a bottom and being in cylindrical shape, a rectangular base 32 and a joint member 30 in approximately rectangular parallelepiped shape.

The joint member 30 is made of a metal material of low thermal expansion coefficient that is relatively similar to the thermal expansion coefficient of the first vessel 20 and may be a magnetic body (for example, 42-alloy or kovar) or a non-magnetic body (for example, Ni-28Mo-2Fe). According to this embodiment, the joint member 30 is a magnetic body. The joint member 30 has a rectangular opening 30h formed in one face (lower face, the face opposed to the base 32) thereof. The joint member 30 also has an opening 30j formed in the upper face that is opposed to the one face. The joint member 30 also has a side face 30c arranged to connect the peripheral edge of the opening 30j with the peripheral edge of the opening 30h. The peripheral edge of the opening 30j is air-tightly joined with an end face 28p that defines the opening 28 of the first vessel 20 by brazing that uses, for example, silver solder. The peripheral edge of the lower end that forms the opening 30h is air-tightly joined with the base 32 by, for example, laser welding or resistance welding. The joint member 30 of a magnetic body has the lower magnetic flux density of the permanent magnets 800 passing through the internal space formed by the joint member 30, compared with the joint member of a non-magnetic body.

The base 32 is a magnetic body and is made of a metal magnetic material, for example, iron or stainless 430. A through hole 32h is formed near the center of the base 32 to allow insertion of a fixed iron core 70 (FIG. 4) described later.

The iron core case 80 is a non-magnetic body. The iron core case 80 has a bottom and is formed in cylindrical shape. The iron core case 80 includes a circular bottom section 80a, a tubular section 80b in cylindrical shape extended upward from the outer edge of the bottom section 80a, and a flange section 80c extended outward from the upper end of the tubular section 80b. The whole circumference of the flange section 80c is air-tightly joined with the peripheral edge of the through hole 32h of the base 32 by, for example, laser welding.

The air-tight joint of the respective members 10, 20, 30, 32 and 80 as described above internally form the air-tight space 100. Hydrogen or a hydrogen-based gas is confined in the air-tight space 100 at or above the atmospheric pressure (for example, at 2 atm), in order to prevent heat generation of the fixed contact 18 and the movable contact 58 by electric arc. More specifically, after the joint of the respective members 10, 20, 30, 32 and 80, the air-tight space 100 is vacuumed via a vent pipe 69 arranged to communicate the inside with the outside of the air-tight space 100 shown in FIG. 4. After such vacuuming, the gas like hydrogen is confined to a predetermined pressure via the vent pipe 69 in the air-tight space 100. After the gas like hydrogen is confined at the predetermined pressure, the vent pipe 69 is caulked to prevent leakage of the gas like hydrogen from the air-tight space 100.

The following describes the movable contact member 50. As shown in FIG. 6, the movable contact member 50 is placed in the air-tight space 100. The movable contact member 50 is moved to come into contact with and separate from the respective fixed contacts 18 (contact and separation) by the function of the driving structure described later. In other words, the movable contact member 50 is movable in the vertical direction by the driving structure described later and comes into contact with the pair of fixed terminals 10 to electrically connect the fixed terminals 10 with each other. The movable contact member 50 is arranged to face the two fixed terminals 10. The movable contact member 50 is a plate-like member having electrical conductivity and is made of, for example, a copper-containing metal material. According to this embodiment, during supply of electric current from the DC power source 2 to the motor 4 (FIG. 1), the contacts 18 and 19 come into contact with each other (FIG. 6A shows the contacts 18 and 19 in non-contact state). Electric current I then flows through the movable contact member 50 in the direction from the positive fixed terminal 10W to the negative fixed terminal 10X as shown by an arrow R1. The respective fixed terminals 18 and the respective movable contacts 58 that come into contact with the fixed terminals 18 are placed inside the first vessel 20 in the air-tight space 100.

The movable contact member 50 includes a center section 52, extended sections 54 and movable contact portions 56. The movable contact portions 56 are arranged to face the fixed contact portions 19. The movable contact area 56 has a movable contact 58 formed on the outer surface thereof. With respect to the flow direction R1 of the electric current flowing through the movable contact member 50 (hereinafter simply called “flow direction R1”), the center section 52 is located between the pair of movable contact portions 56. The center section 52 is extended in the horizontal direction (Y-axis direction). According to this embodiment, the horizontal direction is orthogonal to the moving direction of the movable contact member 50 (simply called the “moving direction”) and is the direction from one fixed terminal 10W (10X) to the other fixed terminal 10X (10W). The shape of the center section 52 is not specifically limited and is, for example, plate-like shape or bar-like shape. The center section 52 has a through hole 53. With respect to the flow direction R1, the extended sections 54 are located between the center section 52 and the pair of movable contact portions 56 and are extended in the moving direction of the movable contact member 50 (vertical direction). According to this embodiment, the extended sections 54 are connected with the movable contact portions 56 and with the center section 52. The extended sections 54 have a length that is equal to or greater than the thickness of the movable contact member 50. In other words, the extended sections 54 are extended vertically by the length that is equal to or greater than the thickness of the movable contact member 50. As described above, since the movable contact member 50 has the extended sections 54, the center section 52 is arranged further away from the fixed contacts 18 than the movable contact portions 56 with respect to the moving direction. The pair of movable contact portions 56 are extended outward of the relay 5 from the pair of extended sections 54.

The movable contacts 58 are placed inside the first vessel 20 in the air-tight space 100 in the state furthest from the fixed contacts 18. In other words, the movable contacts 58 are always located inside the first vessel 20, irrespective of the movement (displacement) of the movable contact member 50.

The following describes the detailed structure of the permanent magnets 800. As shown in FIGS. 6A, 6B and 7, each permanent magnet 800 is in the non-split, single form. The permanent magnet 800 is in plate-like shape of a fixed thickness. The permanent magnets 800 are arranged to outwardly extend arcs 200 generated during supply of electric current from the DC power source 2 to the motor 4. More specifically, the permanent magnets 800 are arranged to apply the Lorentz force in a direction of separating the pair of arcs 200 generated between the fixed contacts 18 and the movable contacts 58 from each other. In particular, the permanent magnets 800 are arranged to form a magnetic flux φ from the negative X-axis direction to the positive X-axis direction as shown in FIG. 6B. According to this embodiment, the permanent magnets 800 are placed on both sides that face each other across a predetermined face Fa including the movable contact member 50 and the pair of fixed terminals 10 electrically connected by the movable contact member 50 as shown in FIG. 7. The predetermined face Fa is defined by the moving direction of the movable contact member 50 (vertical direction, Z-axis direction) and the direction where the pair of fixed terminals 10 face each other (horizontal direction, Y-axis direction). According to this embodiment, the predetermined face Fa makes the fixed terminal 10 line-symmetric and corresponds to the 3-3 cross section of FIG. 3B. In other words, the predetermined face F1 represents the face including the movable contact member 50 and the pair of fixed terminals 10 that are electrically connected by the movable contact member 50. As described above, the pair of permanent magnets 800 are arranged to face the movable contact member 50 and the pair of fixed terminals 10. The single permanent magnet 800 is continuously arranged to be overlapped with the pair of fixed contacts 18 and the pair of movable contacts 58 in vertical projection to a projection plane parallel to the predetermined face Fa. The continuous arrangement of the permanent magnet 800 has the higher magnetic flux density than the discrete arrangement of the permanent magnets 800 of the same thickness. Additionally, non-split arrangement of magnets advantageously reduces the manufacturing cost. The “single” form includes not only the single-pole permanent magnet but the multipole permanent magnet, includes not only the permanent magnet made of a single material but the permanent magnet made of a composite material, and includes the combination of a permanent magnet with another member that does not affect the magnetic force. The “single” form also includes permanent magnets in a continuous shape (along the Y-axis direction) aligned in the moving direction of the movable contact member 50 (Z-axis direction) to cover the pair of fixed contacts 18 and the pair of movable contacts 58. The center point on the magnetic pole face of the permanent magnet is preferably located at the center position between the pair of movable contact portions. Only one permanent magnet 800 may be placed on either one of the first side and the second side across the predetermined face Fa. In the application using only one permanent magnet 800, the permanent magnet 800 should be arranged to generate a magnetic flux φ from the negative X-axis direction to the positive X-axis direction, like the above embodiment.

As shown in FIGS. 6A and 7, the relay 5 is configured, such that the permanent magnets 800 are overlapped with the pair of movable contacts 58 and the pair of fixed contacts 18 but are not overlapped with the center section 52 in vertical projection to a plane parallel to the predetermined face. In other words, with respect to the moving direction of the movable contact member 50, the pair of movable contacts 58 and the pair of fixed contacts 18 are positioned in the area where the permanent magnets 800 are located, while the center section 52 is not positioned in the area where the permanent magnets 800 are located. These relative positions are maintained, irrespective of the movement (displacement) of the movable contact member 50 by the driving structure 90. At such location of the permanent magnets 800, the magnetic flux density that generates the Lorentz force, which acts on the electric current flowing through the movable contact member 50 in the moving direction of the movable contact member 50 (vertical direction) (i.e., the density of the magnetic flux from the negative X-axis direction to the positive X-axis direction) has the following relationship. A center area RX where the center section 52 is located has the lower magnetic flux density than movable contact portions RV where the movable contacts 58 are located. The magnitude relation between the magnetic flux densities of the movable contact portions RV and the center area RX may be defined as described below. In the contact state that the fixed contacts 18 are in contact with the movable contacts 58 (in the ON state of the relay 5), comparison between a minimum magnetic flux density Brv of the movable contact portions RV and a maximum magnetic flux density Brx of the center area RX should result in the magnitude relation of “magnetic flux density Brv>magnetic flux density Brx”. This magnitude relation can reduce the Lorentz force acting on the electric current flowing through the center section 52 in the direction of moving the movable contact member 50 away from the fixed terminals 10 (downward direction, negative Z-axis direction), compared with the magnitude relation that the magnetic flux density of the center area RX is equal to the magnetic flux density of the movable contact portions RV. In the description herein, the Lorentz force acting on the movable contact member 50 in the direction of moving away from the fixed terminals 10 is also called “electromagnetic repulsion”.

Equipment including a commercially available gaussmeter (for example, hand-held gaussmeter: model 410 manufactured by Lake Shore Cryotonics, Inc.) in combination with a dedicated probe (for example, transverse probe: model MST-410 manufactured by Lake Shore Cryotonics, Inc.) may be used for measurement of the magnetic flux density. A concrete procedure of measurement may make a hole for insertion of the probe in a measurement sample (relay main unit 6 in this embodiment) and makes a measurement with the inserted probe. The magnetic flux density may be calculated by computer simulation. Calculation of the magnetic flux density distribution by computer simulation may create a model on analysis software and enter the values of physical properties measured in advance for the component parts actually used for the relay 5, for example, the coercive force of the permanent magnets 800 and material values such as the specific magnetic permeability of the respective component parts, into the analysis software. The calculation of the magnetic flux density by computer simulation enables determination of the magnitude relation between the magnetic flux density Brv and the magnetic flux density Brx when the magnetic flux density of the measurement sample is significantly affected by making the hole for insertion of the probe or when the measurement sample is too small to be measured with the probe.

The following describes the driving structure 90 with reference to FIG. 4. The driving structure 90 includes a rod 60, a base 32, a fixed iron core 70, a movable iron core 72, an iron core case 80, a coil 44, a coil bobbin 42, a coil case 40, a first spring 62 as an elastic member and a second spring 64 as another elastic member. In order to bring the respective movable contacts 58 into contact with the corresponding fixed contacts 18, the driving structure 90 moves the movable contact member 50 in a direction that the movable contacts 58 face the fixed contacts 18 (vertical direction, Z-axis direction). More specifically, the driving structure 90 moves the movable contact member 50 to bring the respective movable contacts 58 into contact with the corresponding fixed contacts 18 or to separate the respective movable contacts 58 from the corresponding fixed contacts 18. In other words, the driving structure 90 sets the relay 5 in either the ON state or the OFF state.

The coil 44 is wound on the resin coil bobbin 42 in hollow cylindrical shape. The coil bobbin 42 includes a bobbin main body 42a in cylindrical shape extended in the vertical direction, an upper face 42b extended outward from the upper end of the bobbin main body 42a and a lower face 42c extended outward from the lower end of the bobbin main body 42a.

The coil case 40 is a magnetic body and is made of a metal magnetic material, for example, iron. The coil case 40 is formed in concave shape. More specifically, the coil case 40 includes a rectangular bottom section 40a and a pair of side face sections 40b extended upward (in the vertical direction) from the peripheral edges of the bottom section 40a. A through hole 40h is formed on the center of the bottom section 40a. The coil case 40 has the coil bobbin 42 placed inside thereof. The coil case 40 surrounds the coil 44 to allow passage of magnetic flux. The coil case 40, in combination with the base 32, the fixed iron core 70 and the movable iron core 72, forms a magnetic circuit as described below.

The iron core case 80 has a disc-shaped rubber element 86 and a disc-shaped bottom plate 84 placed on the bottom section 80a. The iron core case 80 passes through inside of the bobbin main body 42a and the through hole 40h of the coil case 40. A cylindrical guide element 82 is placed between the lower end of the tubular section 80b and the coil case 40 and the coil bobbin 42. The guide element 82 is a magnetic body and is made of a metal magnetic material, for example, iron. The presence of the guide element 82 enables the magnetic force generated during energization of the coil 44 to be efficiently transmitted to the movable iron core 72.

The fixed iron core 70 is in columnar shape and includes a columnar main body 70a and a disc-shaped upper end 70b extended outward from the upper end of the main body 70a. A through hole 70h is formed along from the upper end to the lower end of the fixed iron core 70. The through hole 70h is formed near the center of the circular cross section of the main body 70a and the upper end 70b. Part of the fixed iron core 70 including the lower end of the main body 70a is placed inside the iron core case 80. The upper end 70b is arranged to be protruded on the base 32. A rubber element 66 is placed on the outer surface of the upper end 70b. An iron core cap 68 is additionally placed on the upper surface of the upper end 70b via the rubber element 66. The iron core cap 68 has a through hole 68h formed on its center to allow insertion of the rod 60. The iron core cap 68 has the peripheral edge joined with the base 32 by, for example, welding and works to prevent the fixed iron core 70 from moving upward.

The movable iron core 72 is in columnar shape and has a through hole 72h formed along from its upper end to lower end. A recess 72a having a larger inner diameter than the inner diameter of the through hole 72h is formed at the lower end. The through hole 72h communicates with the recess 72a. The movable iron core 72 is placed on the bottom section 80a of the iron core case 80 via the rubber element 86 and the bottom plate 84. The upper end face of the movable iron core 72 is arranged to be opposed to the lower end face of the fixed iron core 70. As the coil 44 is energized, the movable iron core 72 is attracted to the fixed iron core 70 and moves upward.

The second spring 64 is inserted through the through hole 70h of the fixed iron core 70. The second spring 64 has one end that is in contact with the iron core cap 68 and the other end that is in contact with the upper end face of the movable iron core 72. The second spring 64 presses the movable iron core 72 in a direction that moves the movable iron core 72 away from the fixed iron core 70 (negative Z-axis direction, downward direction).

The first spring 62 is located between the movable contact member 50 and the fixed iron core 70. The first spring 62 presses the movable contact member 50 in a direction that moves the respective movable contacts 58 closer to the corresponding fixed contacts 18 (positive Z-axis direction, upward direction). A third vessel 34 is placed inside the joint member 30 in the air-tight space 100 (FIG. 6A). The third vessel 34 is made of, for example, a synthetic resin material or a ceramic material and serves to prevent the arc generated between the fixed contact 18 and the movable contact 58 from coming into contact with an electrically conductive member (for example, the joint member 30 as described later). The third vessel 34 is formed in rectangular parallelepiped shape and includes a rectangular bottom face 31 and a side face 37 extended upward from the peripheral edge of the bottom face 31. The third vessel 34 also has a groove-like holder 33 on the bottom face 31. A through hole 34h is also formed in the bottom face 31 to allow insertion of the rod 60. The first spring 62 has one end that is in contact with the center section 52 and the other end that is in contact with the bottom face 31 via an elastic material 95 (for example, rubber). The elastic material 95 is arranged to surround part of a shaft member 60a of the rod 60 and thereby prevents the particulates of the component part of the fixed contact area 19 or the movable contact member 50 scattered by the arc from entering the second spring 64. This reduces the possibility that the characteristics of the second spring 64 are affected.

The rod 60 is a non-magnetic body. The rod 60 includes a columnar shaft member 60a, a disc-shaped one end portion 60b provided at one end of the shaft member 60a and an arc-shaped other end portion 60c provided at the other end of the shaft member 60a. The shaft member 60a is inserted through the through hole 53 of the movable contact member 50 to be freely movable in the vertical direction (moving direction of the movable contact member 50). The one end portion 60b is arranged on the other face of the center section 52 opposite to the face where the first spring 62 is placed in the state that the coil 44 is not energized. The other end portion 60c is located in the recess 72a. The other end portion 60c is also joined with the bottom of the recess 72a. The one end portion 60b restricts the movement of the movable contact member 50 toward the fixed terminals 10 by the second spring 64 in the state that the driving structure 90 is not operated (in the non-energized state). The other end portion 60c is used to move the rod 60 in conjunction with the movement of the movable iron core 72 in the state that the driving structure 90 is operated.

The following describes the operations of the relay 5 with reference to FIG. 4. When the coil 44 is energized (in the ON state of the relay 5), the movable iron core 72 is attracted to the fixed iron core 70. The movable iron core 72 accordingly moves closer to the fixed iron core 70 against the pressing force of the second spring 64 to be in contact with the fixed iron core 70. As the movable iron core 72 moves upward, the rod 60 also moves upward. The one end portion 60b of the rod 60 accordingly moves upward. This eliminates the restriction on the movement of the movable contact member 50 and enables the movable contact member 50 to move upward (direction closer to the fixed contacts 18) by the pressing force of the first spring 62. As a result, the respective movable contacts 58 come into contact with the corresponding fixed contacts 18, so as to establish electrical continuity between the two fixed terminals 10 via the movable contact member 50 (the relay 5 is in the conduction state)

When power supply to the coil 44 is cut off (in the OFF state of the relay 5), on the other hand, the movable iron core 72 moves downward to be away from the fixed iron core 70 mainly by the pressing force of the second spring 64. The movable contact member 50 is then pressed by the one end portion 60b of the rod 60 to move downward (in the direction moving away from the fixed contacts 18). The respective movable contacts 58 are accordingly separated from the corresponding fixed contacts 18, so as to cut off the electrical continuity between the two fixed terminals 10 (the relay 5 is in the non-conduction state).

When the coil 44 is energized, the movable conductor 50 moves to establish electrical continuity between the two fixed terminals 10, and when power supply to the coil 44 is cut off, the movable contact member 50 moves back to the original position to break the electrical continuity between the two fixed terminals 10. An arc is generated between the movable contact 58 and the fixed contact 18 in the course of opening or closing the contacts 58 and 18. The generated arc is extended in the Y-axis direction to be extinguished by the permanent magnets 800 mounted on the outer casing 7.

As described above, the relay 5 of the first embodiment has the magnitude relation that the center area RX has the lower magnetic flux density of the permanent magnets 800 than the movable contact portions RV. This arrangement reduces the electromagnetic repulsion against the electric current flowing through the movable contact member 50 when the driving structure 90 is driven to set the relay 5 in the ON state. This advantageously maintains the stable contact between the contacts 18 and 58. This also reduces the required force (pressing force) of the first spring 62 to be applied to the movable contact member 50 corresponding to the reduction of the electromagnetic repulsion, in order to bring the contacts 18 and 58 of the relay 5 into contact with each other by a predetermined force (for example, 5 N) and maintain the favorable contact state. This results in reducing the required force (pressing force) of the second spring 64 to move the movable contact member 50 away from the fixed terminals 10 against the pressing force of the first spring 62. Such reduction accordingly reduces the required magnetic force to press up the movable iron core 72 toward the fixed iron core 70 against the pressing force of the second spring 64. The relay 5 of the embodiment can thus decrease the number of winds of the coil 44 and reduce the electric current used to energize the coil 44. This effectively enables downsizing of the relay 5 and reduction of the power consumption. Especially in the application of the relay 5 that is placed and used in a circuit where high current (for example, 5000 A or higher) flows, this effectively prevents size expansion of the relay 5 and increase in power consumption. The single magnet used for the permanent magnet 800 advantageously reduces the manufacturing cost of the relay 5, compared with the split magnets.

### B. Second Embodiment

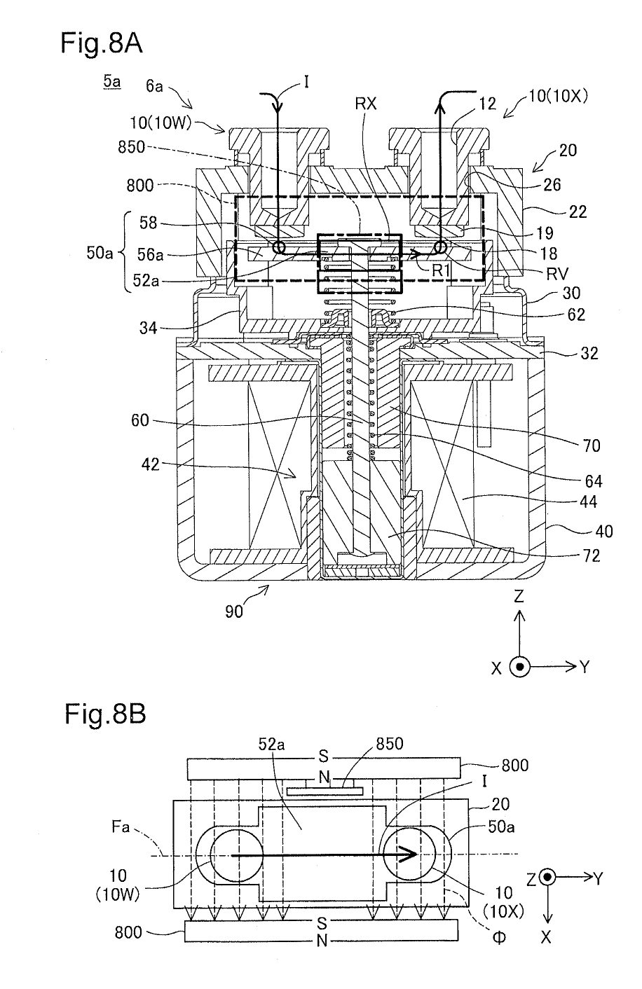

FIGS. 8A and 8B are diagrams illustrating a relay 5a according to a second embodiment. FIG. 8A is a diagram equivalent to the 3-3 cross sectional view of FIG. 3B. FIG. 8B is a diagram showing the positional relationship between permanent magnets 800 and a magnetic shield 850. Like the first embodiment, a relay main unit 6a is surrounded and protected by the outer casing 8 (FIG. 2). The differences from the relay 5 of the first embodiment include the shape of a movable contact member 50a, addition of the magnetic shield 850 and the positional relationship between the permanent magnets 800 and the movable contact member 50a. The other structure (for example, the driving structure 90) is similar to that of the first embodiment. The like parts are expressed by the like numerals or symbols and are not specifically described here. In FIG. 8A, for the purpose of clearly specifying the positions of the permanent magnets 800 and the magnetic shield 850, the outline of the permanent magnet 800 is shown by the dotted line and the outline of the magnetic shield 850 is shown by the dash-dot line.

As shown in FIG. 8A, the movable contact member 50a is plate-like form of a fixed thickness. Like the first embodiment, the movable contact member 50a has a pair of movable contacts 58 and a center section 52a located between the pair of movable contacts 58. Movable contact portions 56a including the movable contacts 58 and the center section 52a are arranged at the same height with respect to the moving direction of the movable contact member 50a.

As shown in FIG. 8A, the permanent magnets 800 are placed on both sides that face each other across a predetermined face Fa including the movable contact member 50a and a pair of fixed terminals 10. In vertical projection of the relay 5a on a plane parallel to the predetermined face Fa, the permanent magnets 800 are overlapped with the pair of fixed contacts 18 and the movable contact member 50a including the pair of movable contacts 58 and the center section 52a.

A plate-like magnetic body may be adopted for the magnetic shield 850. The magnetic shield 850 may be a magnetic body (for example, iron). The magnetic shield 850 reduces the magnetic flux density that applies the Lorentz force to the electric current flowing through the center section 52a. As shown in FIGS. 8A and 8B, the magnetic shield 850 is located between the center section 52a and the permanent magnet 800 that releases the magnetic flux toward the movable contact member 50a (the permanent magnet 800 located on the negative X-axis direction side). Additionally, another magnetic shield 850 may be located between the center section 52a and the permanent magnet 800 which the magnetic flux passing through the movable contact member 50a enters (the permanent magnet 800 located on the positive X-axis direction side).

As described above, the presence of the magnetic shield 850 enables the center area RX where the center section 52a is located to have the lower magnetic flux density than the movable contact portions RV where the movable contacts 58 are located. This magnitude relation enables reduction of the electromagnetic repulsion, compared with the magnitude relation that the magnetic flux density of the center area RX is equal to the magnetic flux density of the movable contact portions RV. This maintains the stable contact between the pair of fixed contacts 18 and the movable contact member 50 in the ON state of the relay 5a. This arrangement does not require to bend the movable contact member 50a in the moving direction of the movable contact member 50a, thus enabling further downsizing compared with the first embodiment. Like the first embodiment, this arrangement also reduces the magnetic force to press up the movable iron core 72 toward the fixed iron core 70 and reduces the electric current used to energize the coil 44. This results in reduction of the power consumption of the relay 5a.

### C. Third Embodiment

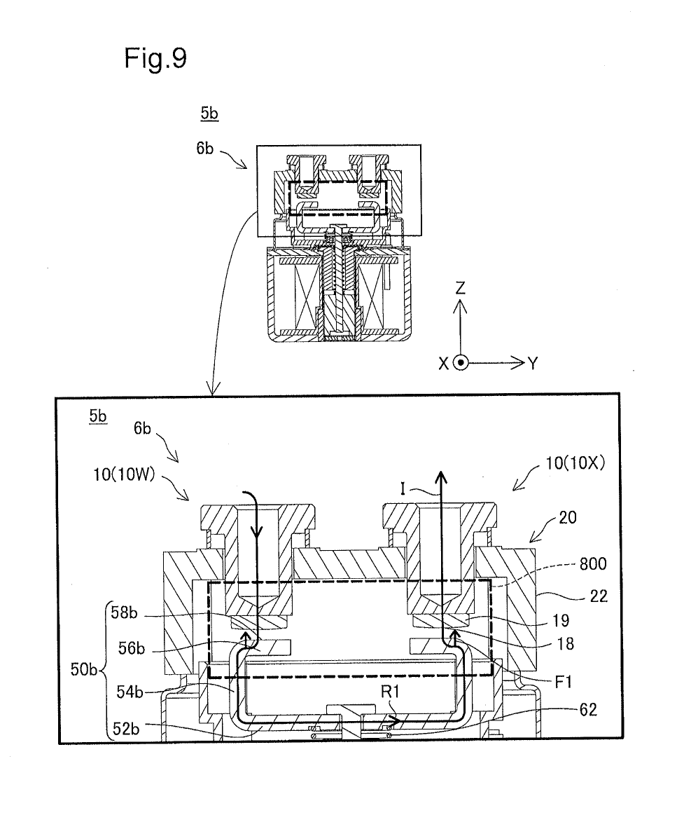

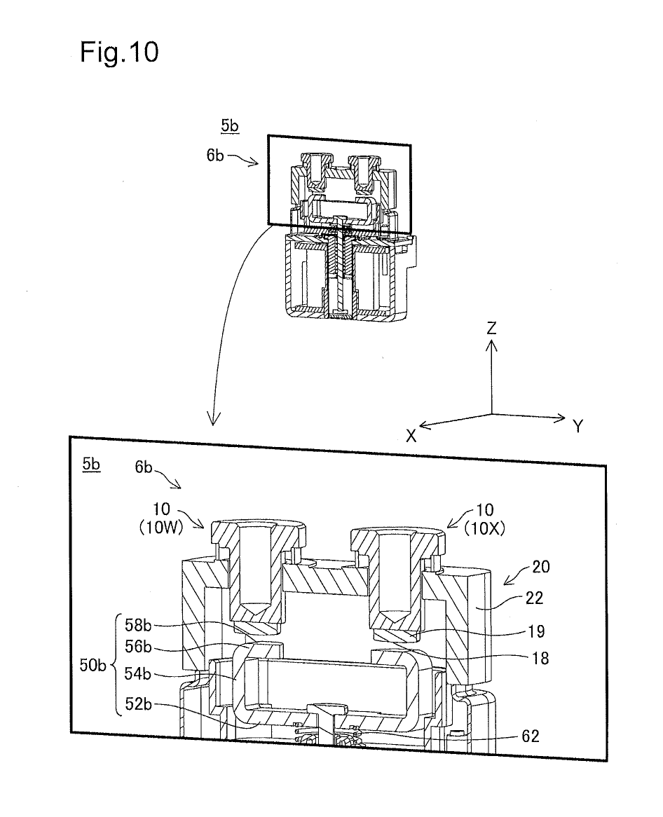

FIG. 9 is a diagram illustrating a relay 5b according to a third embodiment. FIG. 9 is a diagram equivalent to the 3-3 cross sectional view of FIG. 3B. FIG. 10 is a perspective view of a relay main unit 6b shown in FIG. 9. The difference from the relay 5 of the first embodiment is the structure of a movable contact member 50b. The other structure is similar to that of the first embodiment. The like parts are expressed by the like numerals or symbols and are not specifically described here. In FIG. 9, for the purpose of clearly specifying the positions of permanent magnets 800, the outline of the permanent magnet 800 is shown by the dotted line.

As shown in FIG. 9, the movable contact member 50b includes movable contact portions 56b having movable contacts 58b formed on the respective surfaces thereof, extended sections 54b and a center section 52b. The movable contact portions 56b are arranged to face the fixed contact portions 19. With respect to the flow direction R1, the center section 52b is located between the pair of movable contact portions 56b. The center section 52b is extended in the direction where the pair of fixed terminals 10 face each other (horizontal direction, Y-axis direction). With respect to the flow direction R1, the pair of extended sections 54b are located between the center section 52b and the pair of movable contacts 58b. The pair of movable contact portions 56b are extended from the pair of extended sections 54b to be closer to each other. In other words, the pair of movable contact portions 56b are extended inward of the relay 5c from the pair of extended sections 54b. Like the first embodiment, the permanent magnets 800 are placed on both sides that face each other across a predetermined face (sheet surface in this embodiment) to form a magnetic flux from the depth to the front of the sheet surface in the relay main unit 6b. The permanent magnets 800 accordingly cause the Lorentz force to act in the direction of separating a pair of arc currents, which are generated between the contacts 18 and 58b, from each other. In other words, the permanent magnets 800 apply the Lorentz force to the arc currents in the direction outward of the relay 5b.

As described above, the pair of movable contact portions 56b are extended from the extended sections 54b in the directions opposed to each other. The permanent magnets 800 thus serve to apply Lorentz force F1 to the electric current flowing through the movable contact portions 56b in the direction of moving the movable contact portions 56b closer to the fixed terminals 10. This more stably maintains the contact between the pair of fixed contacts 18 and the movable contact member 50b in the ON state of the relay 5b. As described above, in the close state of the contacts 18 and 58b, the Lorentz force F1 acts on the movable contact portions 56b. This structure accordingly reduces the required force (pressing force) of the first spring 62 to be applied to the movable contact member 50 corresponding to the reduction of the Lorentz force F1, in order to bring the contacts 18 and 58b into contact with each other by a predetermined force (for example, 5 N). Such reduction further reduces the required magnetic force to press up the movable iron core 72 toward the fixed iron core 70, compared with the first embodiment. The structure of the relay 5c thus enables further downsizing and further reduction of the power consumption, compared with the relay 5 of the first embodiment.

### D. Fourth Embodiment

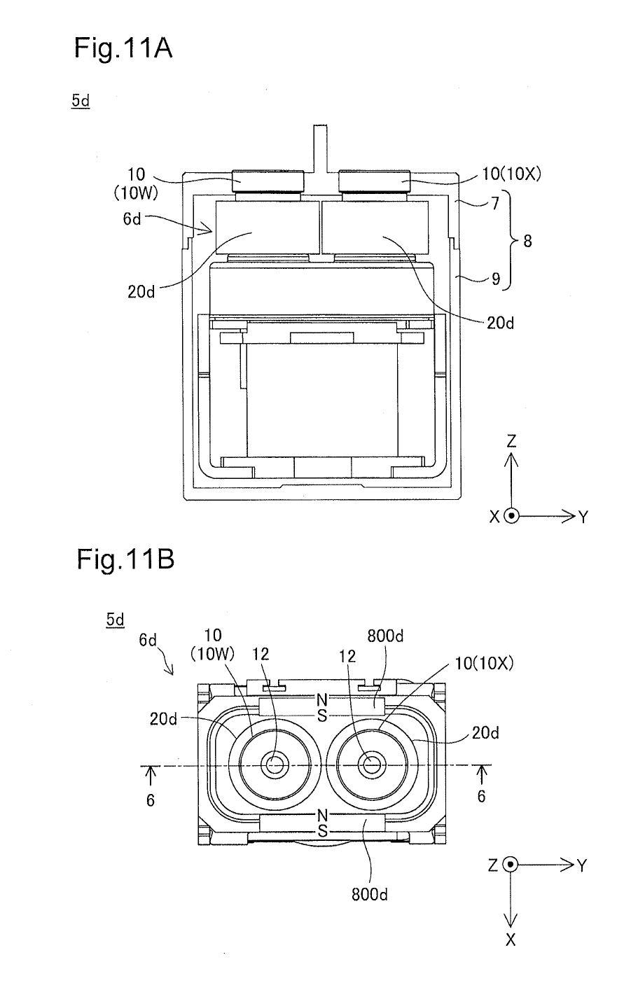

FIGS. 11A and 11B are appearance diagrams of a relay 5d according to a fourth embodiment. FIG. 11A is a first appearance diagram of the relay 5d. FIG. 11B is a second appearance diagram of the relay 5d. For the better understanding, the structure of a relay main unit 6d placed inside an outer casing 8 is also shown by the solid line. FIG. 11B shows permanent magnets 800d included in the relay 5d while omitting the illustration of the outer casing 8 that is shown in FIG. 11A. The differences from the relay 5 of the first embodiment include the structure of first vessels 20d, the direction of a magnetic flux formed by the permanent magnets 800d, the structure of a third vessel described later and the structure of a joint member described later. The other structure (for example, the driving structure 90) is similar to that of the first embodiment. The like parts are expressed by the like numerals or symbols and are not specifically described here. The third vessel and the joint member preferably have the structures described below but may have the structures similar to those described in the first embodiment.

As shown in FIG. 11A, the relay 5d has first vessels 20d corresponding to the respective fixed terminals 10. According to this embodiment, two (pair of) first vessels 20d are provided corresponding to two (pair of) fixed terminals 10. The first vessels 20d are provided as members having insulating properties. The first vessels 20 are made of a ceramic material, for example, alumina or zirconia, and have excellent heat resistance. The first vessel 20 has a bottom and is formed in cylindrical shape. As shown in FIG. 11B, the permanent magnets 800d are arranged to have a magnetic flux in the direction (direction from the positive X-axis direction to the negative X-axis direction) opposite to the direction of the first embodiment. The reason of such arrangement will be described later.

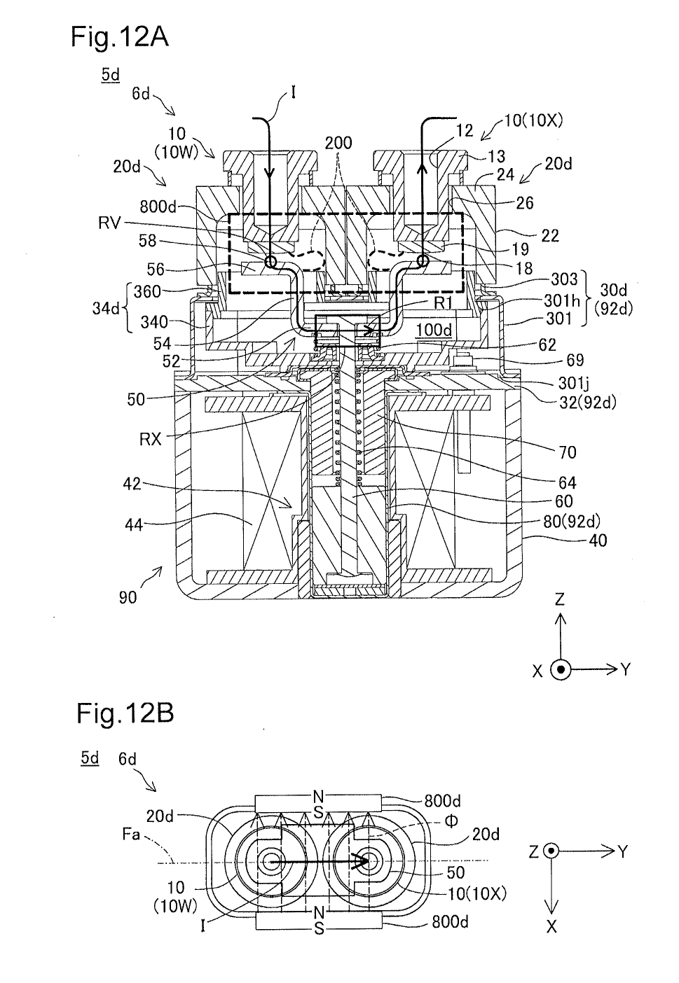

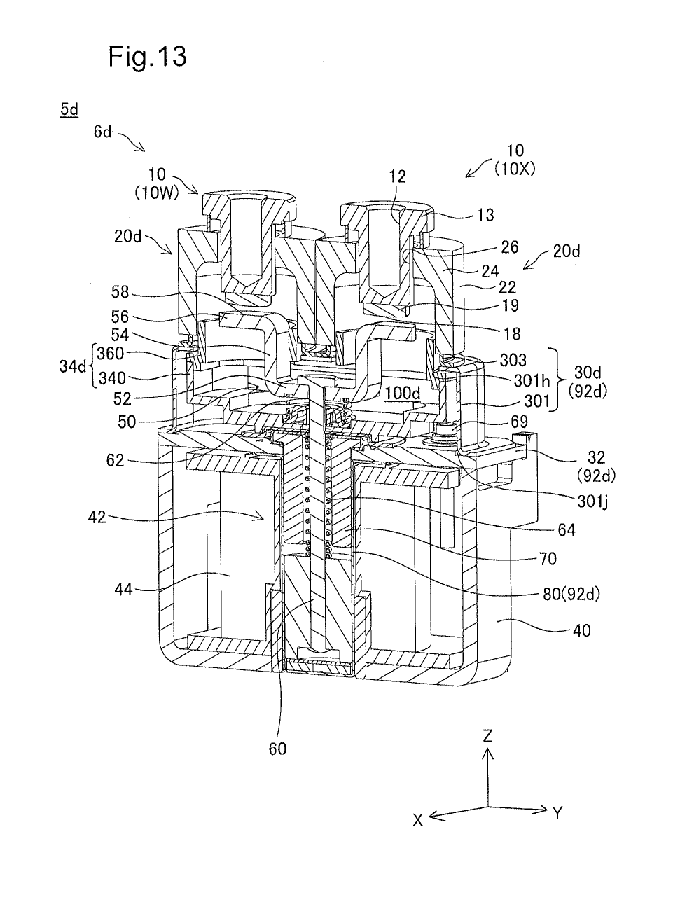

FIGS. 12A and 12B are diagrams illustrating a relay 5d according to a fourth embodiment. FIG. 12A is a 6-6 cross sectional view of FIG. 11B. FIG. 12B is a diagram illustrating the permanent magnets 800d. FIG. 13 is an appearance perspective view of the relay main unit 6d shown in FIG. 12A. In FIG. 12A, for the purpose of clearly specifying the positions of the permanent magnets 800d, the outline of the permanent magnet 800d is shown by the dotted line.

As shown in FIG. 12A, the relay main unit 6d internally has an air-tight space 100d formed by the first vessels 20d, the fixed terminals 10 joined with the first vessels 20d, and a second vessel 92d joined with the first vessels 20d.

Movable contact portions 56 including movable contacts 58 and fixed contact portions 19 including fixed contacts 18 are placed inside the first vessels 20d provided corresponding to the respective fixed terminals 10. More specifically, the movable contact portions 56 and the fixed contact portions 19 are placed inside the first vessels 20d, irrespective of the movement (displacement) of the movable contact member 50. A magnetic flux φ of the permanent magnets 800d is formed to pass through the relay main unit 6d from the positive X-axis direction to the negative X-axis direction as shown in FIG. 12B. The permanent magnets 800d accordingly cause the Lorentz force to act on the electric current flowing through the movable contact portions 56 in the direction of moving the movable contact portions 56 closer to the fixed terminals 10 as shown in FIG. 12A. Since the magnetic field of the permanent magnets 800d passing through the relay main unit 6d is in the reverse direction to that of the first embodiment, the Lorentz force acts on the electric current flowing through the movable contact member 50 in the reverse direction to that of the first embodiment.

As described above, the relay 5d of this embodiment has the permanent magnets 800d that cause the Lorentz force to act on the arcs 200 generated in the course of opening or closing the fixed contacts 18 and the movable contacts 58 in the direction closer to each other. Additionally, the permanent magnets 800d are arranged to apply the Lorentz force to part of the electric current flowing through the movable contact member 50 (more specifically, the electric current flowing through the movable contact portions 56) in the direction of moving the movable contact member 50 closer to the fixed contacts 18. This arrangement maintains the stable contact between the contacts 18 and 58. The Lorentz force acting in the direction of moving the movable contact member 50 closer to the fixed contacts 18 is also called “electromagnetic adsorption”. Generation of electromagnetic adsorption further reduces the required force (pressing force) of the first spring 62 to be applied to the movable contact member 50 to bring the contacts 18 and 58 of the relay 5d into contact with each other by a predetermined force (for example, 5 N). Such reduction results in reducing the required force (pressing force) of the second spring 64 to move the movable contact member 50 away from the fixed terminals 10 against the pressing force of the first spring 62 in the course of opening the contacts 18 and 58. This enables further downsizing of the relay 5d and further reduction of the power consumption.

The joint member 30d includes a first joint member 301 and second joint members 303. The first joint member 301 and the second joint members 303 may be made of, for example, a metal material. According to this embodiment, the second joint members 303 joined with the first vessels 20d made of alumina have the smaller thermal expansion coefficient than the first joint member 303. For example, the first joint member 301 may be made of stainless steel, and the second joint members 303 may be made of kovar or 42-alloy. Intervention of the second joint members 303 having the smaller thermal expansion coefficient between the stainless steel first joint member 301 and the ceramic first vessel 20d relieves the stress produced by the thermal expansion difference between the first vessel 20d and the first joint member 301. This reduces the possibility that the relay main unit 6d is damaged.

Two circular openings 301h are formed on one face (upper face) of the first joint member 301 to allow insertion of part of the movable contact member 50. A rectangular opening 301j is formed in the other face (lower face) of the first joint member 301 opposed to the one face. The second joint members 303 are provided corresponding to the first vessels 20d. According to this embodiment, there are two second joint members 303. The second joint members 303 are in cylindrical shape. The second joint members 303 are joined with the first vessels 20d and with the first joint member 301. More specifically, the first and the second joint members 301 and 303 are air-tightly joined by, for example, laser welding or resistance welding. The second joint members 303 are joined with the first vessels 20d by brazing.

A third vessel 34d includes a lower vessel member 340 and a cover vessel member 360. The lower vessel member 340 and the cover vessel member 360 are made of, for example, a synthetic resin material or a ceramic material. The third vessel 34d serves to prevent arcs 200 generated between the fixed contacts 18 and the movable contacts 58 from coming into contact with any of electrically conductive members (for example, the joint member 30d) or any of joint parts of the respective component parts (for example, the joint parts of the first vessels 20d with the joint member 30d). The joint parts of the first vessels 20d with the second joint members 303 and the joint parts of the first joint member 301 with the second joint members 303 are located to be opposed to the fixed contacts 18 and the movable contacts 58 across the third vessel 34d. In other words, the joint parts of the first vessels 20d with the second joint members 303 and the joint parts of the first joint member 301 with the second joint members 303 are at the positions hidden (unviewable) from the fixed contacts 18 and the movable contacts 58 by the third vessel 34d.

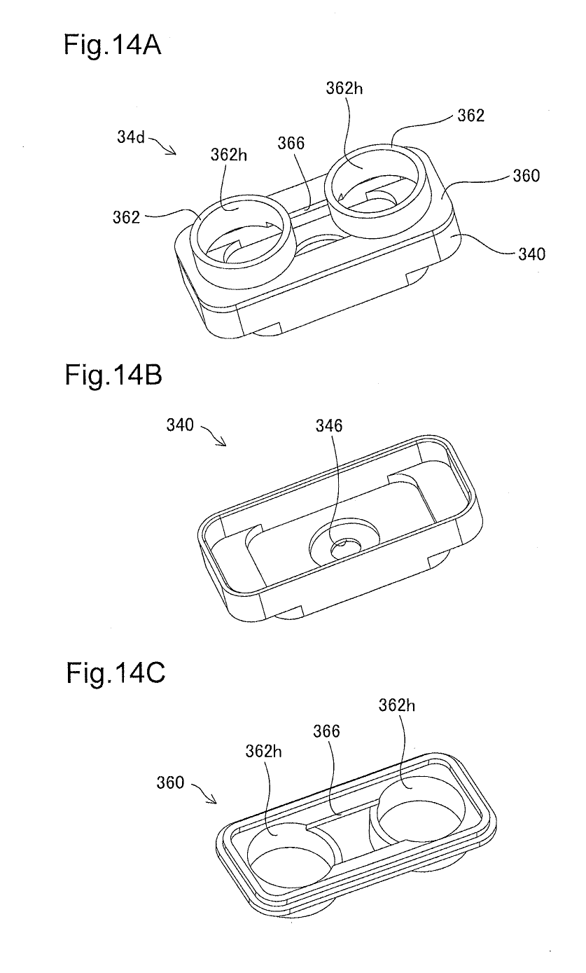

FIGS. 14A to 14C are diagrams illustrating the detailed structure of the third vessel 34d. FIG. 14A is an appearance perspective view of the third vessel 34d. FIG. 14B is an appearance perspective view of the lower vessel member 340. FIG. 14C is an appearance perspective view of the cover vessel member 360.

As shown in FIG. 14A, the third vessel 34d is integrated by fitting the cover vessel member 360 and the lower vessel member 340 each other. As shown in FIGS. 14A and 14C, the cover vessel member 360 has a plurality of through holes 362h and 366 formed to allow insertion of the rod 60 and the movable contact member 50. As shown in FIG. 14B, the lower vessel member 340 has a through hole 346 formed to allow insertion of the rod 60.

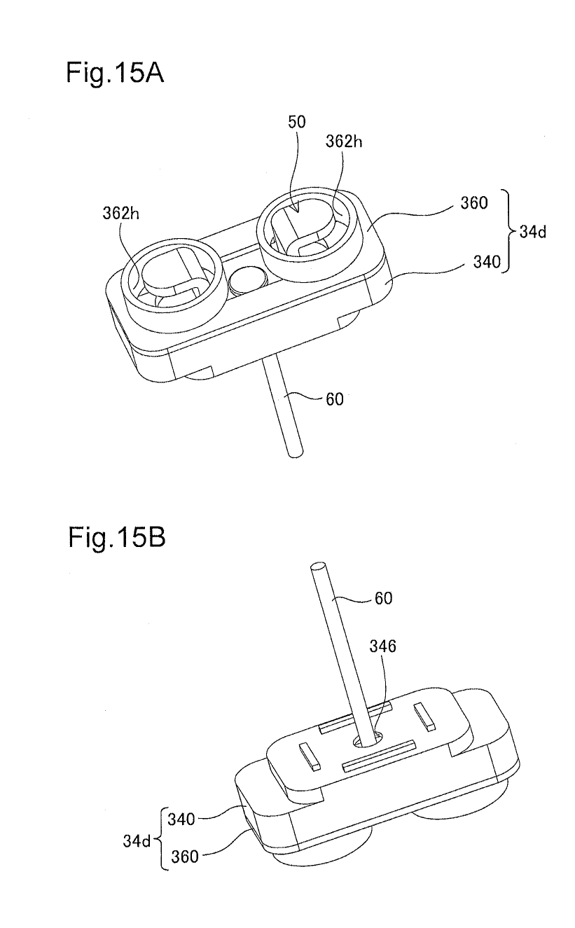

FIGS. 15A and 15B are perspective views illustrating the third vessel 34d, the rod 60 and the movable contact member 50. As shown in FIGS. 15A and 15B, part of the rod 60 and part of the movable contact member 50 are surrounded by the third vessel 34d.

As described above, the permanent magnets 800d included in the relay 5d of the fourth embodiment apply the electromagnetic adsorption to the electric current flowing through the movable contact member 50. This more stably maintains the contact between the contacts 18 and 58 in the ON state of the relay 5d. Generation of electromagnetic adsorption further reduces the required force (pressing force) of the first spring 62 to be applied to the movable contact member 50 to bring the contacts 18 and 58 of the relay 5d into contact with each other by a predetermined force (for example, 5 N). Such reduction results in reducing the required force (pressing force) of the second spring 64 to move the movable contact member 50 away from the fixed terminals 10 against the pressing force of the first spring 62 in the course of opening the contacts 18 and 58. This enables further downsizing of the relay 5d and further reduction of the power consumption. In the arrangement of the permanent magnets 800d to apply the electromagnetic adsorption, the permanent magnets 800d cause the Lorentz force to act on the pair of arcs 200 in the direction closer to each other (FIG. 12A). The relay 5d has the first vessels 20d provided corresponding to the respective fixed terminals 10. The first vessels 20d are arranged to surround the movable contact portions 56 and the fixed contact areas 19. This arrangement prevents the arcs 200 extended in the direction closer to each other from colliding with each other to cause a short circuit. The relay 5d has the plurality of first vessels 20d provided corresponding to the plurality of fixed contacts 18. Even when generation of the arcs 200 scatters the particulates of the component part of the fixed terminal 10, this structure enables the first vessels 20 to work as the barriers and thereby effectively reduces the possibility that the scattered particulates establish electrical continuity between the pair of fixed terminals 10. As an arc is generated between the contacts 18 and 58, the temperature of the air-tight space 100 rises to expand the gas in the air-tight space 100 and increase the internal pressure of the air-tight space 100. The members forming the air-tight space 100 (for example, the first vessels 20) are thus required to have pressure resistance. The structure having the plurality of first vessels 20d provided corresponding to the plurality of fixed terminals 10 enhances the pressure resistance of the first vessels 20, compared with the structure having only one first vessel 20 provided corresponding to the plurality of fixed terminals 10 (FIG. 4). This reduces the possibility that the relay 5 is damaged.

According to the fourth embodiment, the respective component parts 18, 54 and 800d are arranged, such that the permanent magnets 800d are overlapped with the movable contact areas 56 including the movable contacts 58 and the pair of fixed contacts 18 but are not overlapped with the center section 52 in vertical projection of the relay 5d onto a plane parallel to a predetermined face (sheet surface of FIG. 12A) including the movable contact member 50 and the pair of fixed terminals 10 (FIG. 12A). Alternatively, the respective component parts 18, 54 and 800d may be arranged, such that the permanent magnets 800d are overlapped with the movable contact member 50 including the center section 52 and the pair of fixed contacts 18 in vertical projection of the relay 5d to a plane parallel to the predetermined face. The pair of fixed contacts 18 and the movable contact member 50 may thus be positioned in the area where the permanent magnets 800d are located, with respect to the moving direction of the movable contact member 50. In other words, the structure of the fourth embodiment that generates the electromagnetic adsorption may not necessarily have the magnitude relation of the magnetic flux densities (relation that the area where the center section 52 is located has the lower magnetic flux density than the area where the movable contacts 58 are located), which is held by the relay 5 of the first embodiment. This enables the electromagnetic adsorption to act on the electric current flowing through the center section 52 and more stably maintains the contact between the contacts 18 and 58.

In the application that brings the contacts 18 and 58 into stable contact with each other by a predetermined force (for example, 5N), generation of the electromagnetic adsorption further reduces the required pressing force of the first spring 62. Such reduction accordingly reduces the required magnetic force to press up the movable iron core 72 toward the fixed iron core 70 against the pressing force of the second spring 64. The relay 5d of the embodiment can thus more effectively decrease the number of winds of the coil 44 and reduce the electric current used to energize the coil 44. This effectively enables further downsizing of the relay 5d and further reduction of the power consumption. According to this embodiment, the first joint member 301 is preferably a non-magnetic body (for example, stainless steel 304). The first joint member 301 of a non-magnetic body facilitates passage of the magnetic flux, compared with the first joint member 301 of a magnetic body. This increases the electromagnetic adsorption applied to the center section 52 by the permanent magnets 800d. This enables further downsizing of the relay 5d and further reduction of the power consumption.

### E. Fifth Embodiment

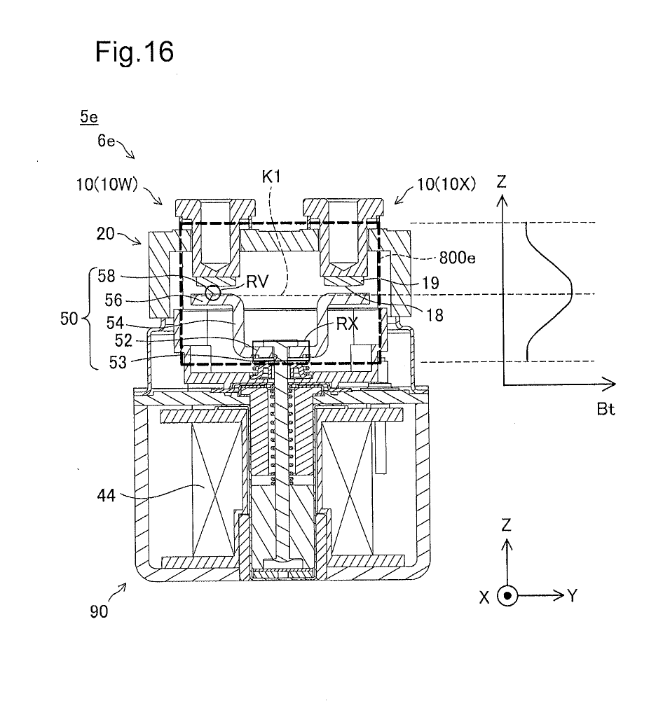

FIG. 16 is a diagram illustrating a relay 5e according to a fifth embodiment. FIG. 16 is a diagram equivalent to the 3-3 cross sectional view of FIG. 3B. Like the first embodiment, a relay main unit 6e is surrounded and protected by the outer casing 8 (FIG. 2). Permanent magnets 800e are located between the outer casing 8 and the relay main unit 6e and are placed on both sides that face each other across a predetermined face (sheet surface of FIG. 16). The difference from the relay 5 of the first embodiment is the size of the permanent magnets 800e. The other structure is similar to that of the first embodiment. The like parts are expressed by the like numerals or symbols and are not specifically described here.

The permanent magnets 800e are longer in the moving direction of the movable contact member 50 (vertical direction, Z-axis direction) than the permanent magnets 800 of the first embodiment. The movable contact member and the pair of fixed contacts 18 are positioned in the area where the permanent magnets 800e are located, with respect to the moving direction of the movable contact member 50. In vertical projection of the relay 5e onto a plane parallel to the predetermined face including the movable contact member 50 and the pair of fixed terminals 10 (sheet surface of FIG. 16), the permanent magnets 800e are accordingly arranged to be overlapped with the fixed contacts 18 and the movable contact member 50. More specifically, a center area RX where the center section 52 is located is at the position further away from a center K1 of the permanent magnet 800e than movable contact portions RV where the pair of movable contacts 58 are located. In general, the magnetic flux density that passes through the relay main unit 6e is lower at both edges of the permanent magnet 800e than the center of the permanent magnet 800e, with respect to the moving direction of the movable contact member 50 (Y-axis direction). As shown in FIG. 16, magnetic flux density Bt formed in the relay 5e is thus lower in the center area RX than in the movable contact portions RV.

As described above, the relay 5e of the fifth embodiment has the magnitude relation that the center area RX has the lower magnetic flux density of the permanent magnets 800e than the movable contact portions RV. Like the first embodiment, this arrangement reduces the electromagnetic repulsion and advantageously maintains the stable contact between the contacts 18 and 58 in the ON state of the relay 5e. Like the first embodiment, this arrangement can decrease the number of winds of the coil 44 and reduce the electric current used to energize the coil 44. This enables downsizing of the relay 5 and reduction of the power consumption.

### F. Sixth Embodiment

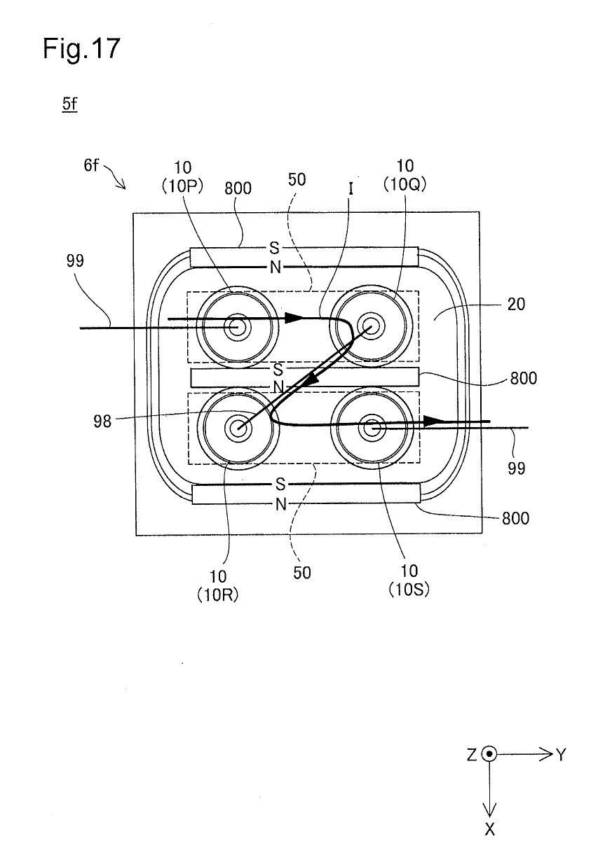

FIG. 17 is a diagram illustrating a relay 5f according to a sixth embodiment. FIG. 17 is a diagram showing a relay main unit 6d and permanent magnets 800 viewed in the Z-axis direction (directly above). Like the first embodiment, a relay main unit 6f is surrounded and protected by the outer casing 8 (FIG. 2). The differences from the first embodiment include the number of fixed terminals 10, the number of first vessels 20, the number of movable contact members 50, the number of permanent magnets 800 and the structure of driving structures operated to drive the movable contact members 50. The other structure is similar to that of the first embodiment. The like parts are expressed by the like numerals or symbols and are not specifically described here. For convenience of explanation, the plurality of fixed terminals 10 are shown by additional symbols 10P, 10Q, 10R and 10S in parentheses for the purpose of differentiation.

The relay main unit 6f includes four fixed terminals 10 respectively having fixed contacts, two movable contact members 50 respectively having movable contacts opposed to the respective fixed contacts, and first vessels 20 joined with the respective fixed terminals 10 and arranged to have insulating properties. The relay main unit 6f also includes two driving structures operated to individually drive the two movable contact members 50. The main structure of the two driving structures is similar to the structure of the driving structure 90 of the first embodiment (FIG. 4). The two driving structures share the base 32, the iron core case 80, the coil 44, the coil bobbin 42 and the coil case 40 but individually have the rod 60, the fixed iron core 70, the movable iron core 72, the first spring 62 and the second spring 64.

One fixed terminal 10P of two fixed terminals 10P and 10Q that are arranged to come into contact with and separate from one movable contact member 50 is electrically connected with wire 99 of the electric circuit 1 (FIG. 1). The other fixed terminal 10Q is electrically connected by wire 98 with one fixed terminal 10R of two fixed terminals 10R and 10S that are arranged to come into contact with and separate from the other movable contact member 50. The other fixed terminals 10S is electrically connected with the wire 99 of the electric circuit 1. The plurality of (four) fixed terminals 10P to 10S are thus electrically connected in series via the two movable contact members 50.

The permanent magnets 800 are placed on a first set of both sides and a second set of both sides across predetermined faces, each including the movable contact member 50 and the pair of fixed terminals 10 electrically connected by the movable contact member 50. Like the first embodiment, the permanent magnets 800 are arranged to cause the Lorentz force to act on a pair of arcs, which are generated between the fixed contacts 18 and the movable contacts, in the direction of separating the arcs from each other. Additionally, like the first embodiment, with respect to the moving direction of the movable contact member 50 (vertical direction, Z-axis direction), the pair of movable contacts and the pair of fixed contacts are positioned in the area where the permanent magnets 800 are located, while the center section 52 of the movable contact member 50 is not positioned in the area where the permanent magnets 800 are located.

As described above, the relay 5f of the sixth embodiment can reduce the electromagnetic adsorption acting on the center section 52, like the first embodiment. The relay 5f can also decrease the voltage between each pair of the fixed contact and the movable contact, compared with the first embodiment. This reduces an arc (amount of current) generated between the fixed contact and the movable contact and reduces a potential trouble caused by electric arc, for example, the possibility that the fixed contact and the movable contact adhere to each other by the heat caused by electric arc.

### G. Seventh Embodiment

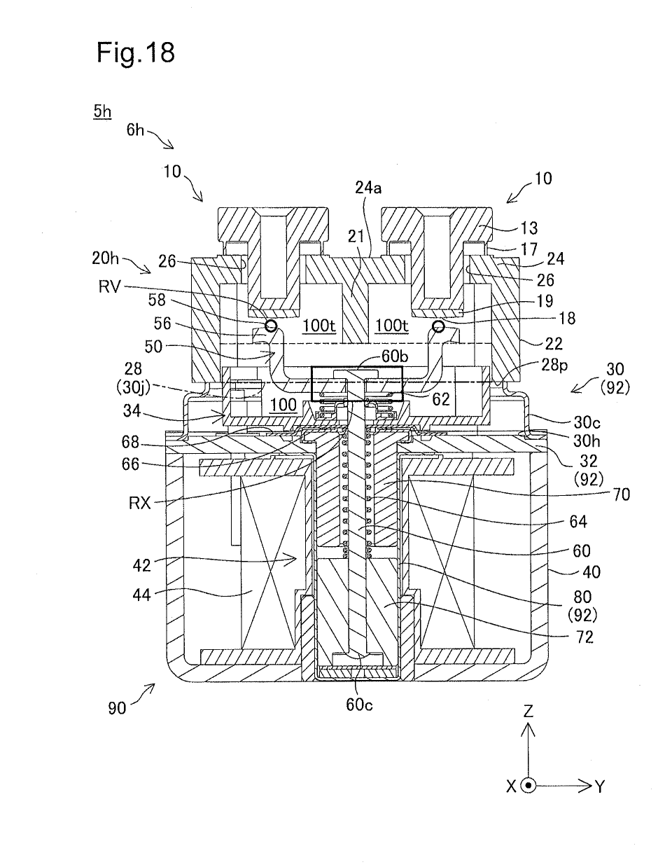

FIG. 18 is a cross sectional view illustrating a relay 5h according to a seventh embodiment. Like FIG. 4, FIG. 18 is a diagram equivalent to the 3-3 cross sectional view of FIG. 3B. The difference from the relay 5 of the first embodiment is that a first vessel 20h has a partition wall member 21. The other structure is similar to that of the relay 5 of the first embodiment. The like parts are expressed by the like numerals or symbols and are not specifically described here. The relay 5h of the seventh embodiment has the similar magnitude relation of the magnetic flux densities to that of the relay 5 of the first embodiment. More specifically, the center area RX where the center section 52 is located has the lower magnetic flux density than the movable contact portions RV where the movable contacts 58 are located.

The first vessel 20h includes a bottom 24 and an opening 28 arranged to face the bottom 24. For the better understanding, the opening 28 is shown by the dash-dot line. The first vessel 20h has a plurality of chambers 100t formed corresponding to the plurality of fixed terminals 10. According to this embodiment, the first vessel 20h has two chambers 100t internally formed corresponding to the two fixed terminals 10. The two chambers 100t are parted from each other by a partition wall member 21. More specifically, the two chambers 100t are formed by the partition wall member 21 and a side face member 22 of the first vessel 20h. For the better understanding, the lower openings of the two chambers 100t are shown by the dotted line. The partition wall member 21 is integrally formed with the other part of the first vessel 20h (for example, the bottom 24). The partition wall member 21 is extended in the direction of the pair of fixed terminals 10 facing each other along a first side face section and a second side face section across the pair of fixed terminals 10 out of the side face member 22 of the first vessel 20h. The first side face section and the second side face section are located on the positive X-axis direction side and on the negative X-axis direction side of the side face member 22 across the air-tight space 100.

The partition wall member 21 is extended from the bottom 24 to a position further away from the bottom 24 than at least the position where the plurality of fixed contacts 18 are located, with respect to the moving direction of the movable contact member 50 (Z-axis direction, vertical direction). According to this embodiment, the partition wall member 21 is extended from the bottom 24 to the position further away from the bottom 24 than the position where the plurality of movable contacts 58 are located, with respect to the moving direction of the movable contact member 50. With respect to the moving direction of the movable contact member 50 (vertical direction, Z-axis direction), the direction that moves the movable contact member 50 closer to the fixed terminals 10 is set to the upward direction (vertically upward direction, positive Z-axis direction), and the direction that moves the movable contact member 50 away from the fixed terminals 10 is set to the downward direction (vertically downward direction, negative Z-axis direction). According to this embodiment, the partition wall member 21 is extended from the bottom 24 to the position below the movable contacts 58, with respect to the moving direction of the movable contact member 50.

Extending the partition wall member 21 from the bottom 24 to the predetermined position causes the respective fixed contacts 18 to be located inside the respective chambers 100t in the air-tight space 100. The respective movable contacts 58 are also located inside the respective chambers 100t in the air-tight space 100. More specifically, the respective movable contacts 58 are always located inside the respective chambers 100t, irrespective of the movement (displacement) of the movable contact member 50. According to the embodiment, the partition wall member 21 is located between the pair of fixed contacts 18 and between the pair of movable contacts 58. In other words, the respective fixed contacts 18 are arranged at the positions across the partition wall member 21. The respective movable contacts 58 are also arranged at the positions across the partition wall member 21.

As described above, the relay 5h of the seventh embodiment includes the first vessel 20h that has the plurality of chambers 100t formed corresponding to the plurality of fixed terminals 10. The plurality of chambers 100t are parted from each other by the partition wall member 21 in the first vessel 20h. The partition wall member 21 is extended from the bottom 24 to the position further away from the bottom 24 than the position where the movable contacts 58 are located, with respect to the moving direction of the movable contact member 50. In other words, the respective fixed contacts 18 and the respective movable contacts 58 are located inside the corresponding chambers 100t in the air-tight space 100. Even when electric arc scatters the particulates of the component part of the fixed terminal 10, this structure enables the partition wall member 21 of the first vessel 20h to work as the barrier and thereby effectively reduces the possibility that the particulates are accumulated to establish electrical continuity between the fixed terminals 10. The movable contacts 58, as well as the fixed contacts 18, are located inside the respective chambers 100t. Even when electric arc scatters the particulates of the component part of the movable contact member 50 including the movable contacts 58, this structure enables the partition wall member 21 of the first vessel 20h to work as the barrier. This more effectively reduces the possibility that the particulates are accumulated to establish electrical continuity between the fixed terminals 10.

### H. Eighth Embodiment

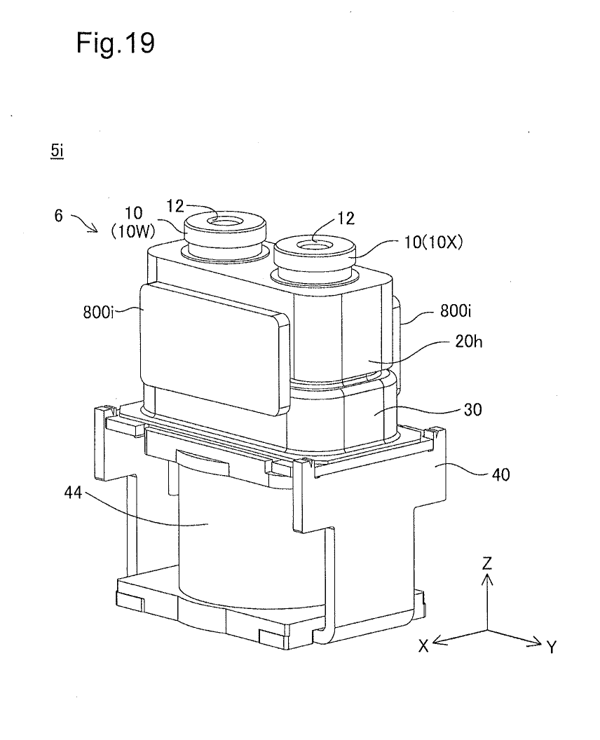

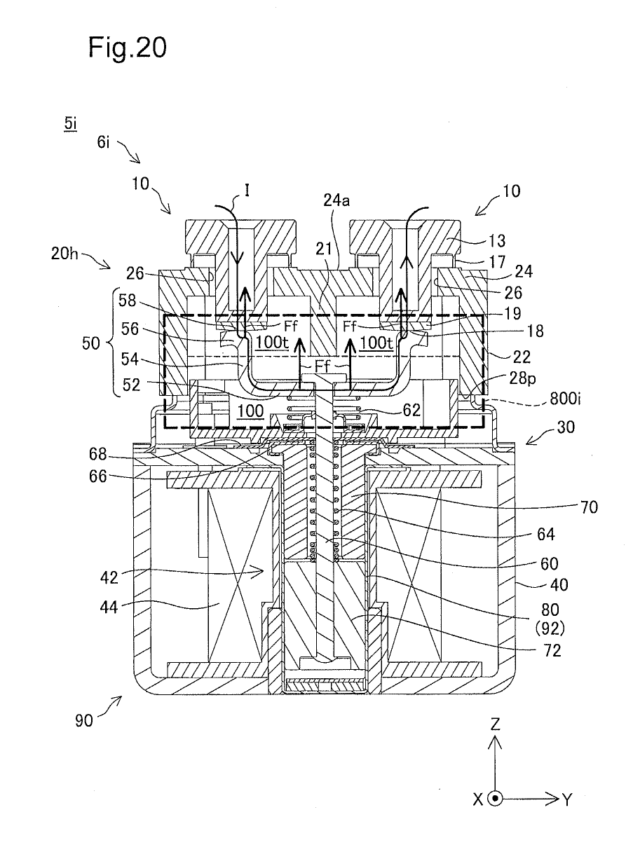

FIG. 19 is an appearance perspective view illustrating a relay 5i according to an eighth embodiment. The outer casing 8 (FIG. 11A) is omitted from the illustration. FIG. 20 is a cross sectional view of FIG. 19. Like FIG. 4, FIG. 20 is a diagram equivalent to the 3-3 cross sectional view of FIG. 3B. For the purpose of clearly specifying the positions of permanent magnets 800i, the outline of the permanent magnet 800i is shown by the dotted line in FIG. 20. The differences between the relay 5i of the eighth embodiment and the relay 5h of the seventh embodiment (FIG. 18) include the size of the permanent magnets 800i and the magnitude relation of the magnetic flux densities. The other structure (for example, the first vessel 20h) is similar to that of the relay 5h the seventh embodiment. The like parts are expressed by the like numerals or symbols and are not specifically described here.

The relay 5i of the eighth embodiment is applied to the electric circuit 1 (also called “system”) that uses a secondary battery as the DC power source 2 (FIG. 1). In other words, the relay 5i is used for the system 1 including a secondary battery. The system 1 includes a load, such as the motor 4. According to this embodiment, during discharge of the secondary battery 2, one of the pair of fixed terminals 10 which the electric current flows in is called positive fixed terminal 10W, and the other which the electric current flows out is called negative fixed terminal 10X. When the secondary battery is used for the DC power source 2, the system 1 may be configured to charge the regenerative energy of the motor 4 into the secondary battery. In this application, the system 1 is equipped with a converter that converts AC power into DC power. According to the other embodiments and modifications, when the secondary battery is used for the DC power source 2, the system 1 includes a converter in addition to the inverter 3. The relay 5i of the eighth embodiment is not limitedly applied to the system 1 that uses the secondary battery for the DC power source 2 but is also applicable to a system that includes any of various power sources, such as a primary battery or a fuel cell, in addition to the secondary battery and the load 4. During power supply from the DC power source 2 to the load 4, one of the pair of fixed terminals 10 which the electric current flows in works as the positive fixed terminal 10W, and the other which the electric current flows out works as the negative fixed terminal 10X.

As shown in FIG. 20, the pair of permanent magnets 800i are placed in the area where the movable contact member 50 is located in the contact state that the movable contact member 50 is in contact with the fixed terminals 10, with respect to the moving direction of the movable contact member 50. As shown in FIG. 20, when electric current flows in the relay 5i during supply of electric power from the DC power source 2 to the motor 4, the pair of permanent magnets 800i generate Lorentz force Ft (electromagnetic adsorption) that acts on electric current I flowing through the movable contact member 50 in the direction of moving the movable contact member 50 closer to the opposed fixed contacts. The permanent magnets 800i are arranged to form a magnetic flux φ from the positive X-axis direction to the negative X-axis direction in the air-tight space 100, in order to generate the electromagnetic adsorption.

In other words, when the secondary battery 2 (FIG. 1) is discharged in the energized state of the coil 44 (in the ON state of the relay 5i), the electric current I flows in the sequence of the positive fixed terminal 10W, the movable contact member 50 and the negative fixed terminal 10X. The permanent magnets 800i then generate the Lorentz force Ff acting on the electric current flowing in a predetermined direction out of the electric current I flowing through the movable contact member 50 in the direction that moves the movable contact member 50 closer to the opposed fixed contacts 18. The electric current flowing in the predetermined direction herein means the electric current flowing in the direction that the pair of fixed terminals 10 establishing electrical continuity by the movable contact member 50 face each other, i.e., in the direction from the positive fixed terminal 10W to the negative fixed terminal 10X (positive Y-axis direction).

As described above, in the relay 5i of the eighth embodiment, the permanent magnets 800i are arranged to generate the Lorentz force (also called “electromagnetic adsorption”) in the direction of moving the movable contact member 50 closer to the opposed fixed terminals 18 when electric current flows in the relay 5g during supply of electric power from the DC power source 2 as the power supply to the motor 4 as the load (FIG. 20). Like the relay 5d of the fourth embodiment described above (FIG. 12A), this arrangement reduces the required force to move the movable iron core 72 and thereby decreases the number of winds of the coil 44. This effectively prevents size expansion of the relay 5i and reduces the power consumption. Especially when high current flows from the DC power source 2 to the load such as the motor 4, the increased electromagnetic adsorption is generated to more stably maintain contact between the contacts 18 and 58.

The pair of permanent magnets 800i are arranged to cover the entire movable contact member 50 in the contact state that the movable contact member 50 is in contact with the fixed terminals 10. This arrangement enables the electromagnetic adsorption to act on the electric current flowing through the center section 52 in addition to the movable contact portions 56. This more stably maintains the contact between the contacts 18 and 58 in the ON state of the relay 5i. This more effectively decreases the number of winds of the coil 44 and prevents size expansion of the relay 5i.

Such arrangement of the permanent magnets 800i to generate the electromagnetic adsorption causes the Lorentz force to act on an arc generated between the contacts 18 and 58 on the side of the positive fixed terminal 10W and an arc generated between the contacts 18 and 58 on the side of the negative fixed terminal 10X to come closer to each other. The first vessel 20h, however, has the partition wall member 21 between the pair of fixed contacts 18 and between the pair of movable contacts 58. This structure effectively prevents the arcs extended in the direction closer to each other from colliding with each other to cause a short circuit. The presence of the partition wall member 21 of the relay 5i enables the partition wall member 21 to work as the barrier even when electric arc scatters the particulates of the component part of the fixed terminal 10 and thereby reduces the possibility that the particulates establish electrical continuity between the fixed terminals 10.

In the eighth embodiment described above, the permanent magnets 800i are arranged at the positions to cover the entire movable contact member 50 (FIG. 20). This arrangement is, however, not restrictive. For example, the permanent magnets 800i may be arranged at the positions to cover at least either of the opposed sections 56 and the center section 52. This modification has the similar advantageous effects to those of the eighth embodiment described above.

### I. Modifications

Among various components described in the above embodiments, the components other than those described in independent claims are additional and may be omitted according to the requirements. The invention is not limited to the above embodiments or examples, but a multiplicity of variations and modifications may be made to the embodiments without departing from the scope of the invention. Some examples of possible modifications are given below.

I-1. First Modification

In the above embodiment, the two permanent magnets 800 are arranged to have surfaces of different polarities faced each other across the movable contact member 50, 50a or 50b and the pair of fixed terminals 10 connected by the movable contact member 50, 50a or 50b. According to one modification, only one permanent magnet 800 may be used instead. In this modified structure, the arc can be extended by a magnetic flux formed by the permanent magnet 800. Like the above embodiment, this modified structure reduces the electromagnetic repulsion and generates the electromagnetic adsorption, thereby maintaining the stable contact between the pair of fixed contacts 18 and the movable contact member 50, 50a or 50b.

I-2. Second Modification

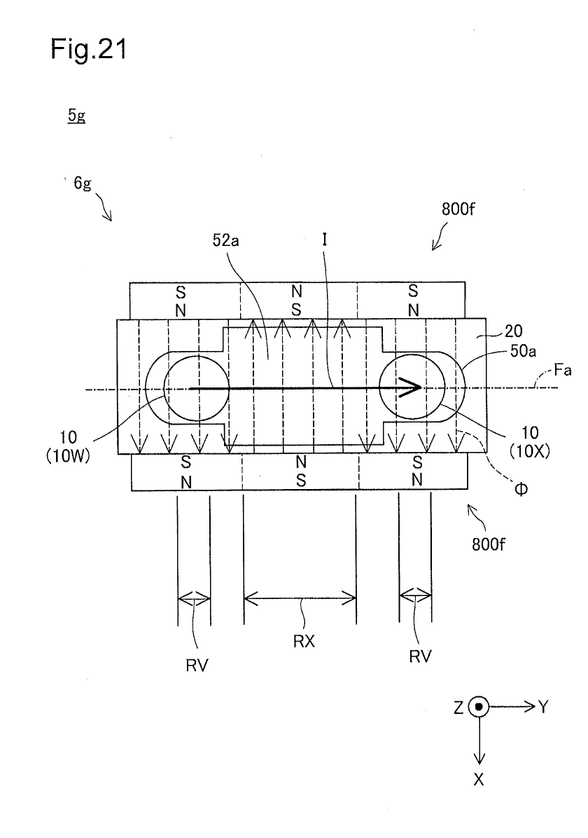

FIG. 21 is a diagram illustrating a relay 5g according to a second modification. FIG. 21 is a diagram showing a relay main unit 6g and permanent magnets 800f from the positive Z-axis direction side. The difference from the relay 5a of the second embodiment (FIGS. 8A and 8B) is the structure of the permanent magnets 800f. The other structure (for example, movable contact member 50a) is similar to that of the second embodiment. The like parts are expressed by the like numerals or symbols and are not specifically described here.

The relay 5g has a pair of permanent magnets 800f arranged to have different polarities opposed to each other. Each permanent magnet 800f is a multipole permanent magnet. More specifically, the permanent magnets 800f are magnetized, such that magnetic fluxes formed in movable contact portions RV are in the reverse direction to a magnetic flux formed in a center area RX. The broken lines represent the boundaries between portions having different arrangements of magnetic poles in each permanent magnet 800f. The pair of permanent magnets 800f apply the Lorentz force to the arc currents generated between the movable contacts and the fixed contacts to be pulled outward of the relay 5g. More specifically, the pair of permanent magnets 800f apply the Lorentz force to extend the pair of arcs (arc generated on the side of the positive fixed terminal 10W and arc generated on the side of the negative fixed terminal 10X) in the direction of separating from each other. Additionally, the pair of permanent magnets 800f cause the Lorentz force to act on the electric current I flowing through the center section 52a of the movable contact member 50 in the direction of moving the movable contact member 50 closer to the fixed terminals 10.

As described above, in the relay 5g, the permanent magnets 800f are placed on the first side and on the second side across the predetermined face Fa including the movable contact member 50 and the pair of fixed terminals 10 electrically connected by the movable contact member 50. The permanent magnets 800f are arranged to apply the Lorentz force in the direction of separating the pair of arcs, which are generated in the course of opening or closing the fixed contacts and the movable contacts, from each other and to cause the electromagnetic adsorption to act on the electric current flowing through the center section 52a. This accelerates extinction of the arcs and maintains the stable contact between the pair of fixed contacts and the movable contact member by generation of the electromagnetic adsorption.

I-3. Third Modification

The above embodiment adopts the mechanism of moving the movable iron core 72 by magnetic force as the driving structure 90. This is, however, not restrictive. Another mechanism may be adopted to move the movable contact member 50. For example, according to one adoptable mechanism, a lift assembly that is extendable by external operation may be placed in the center section 52 of the movable contact member 50 (FIG. 6A) on the opposite side to the side of the fixed terminals 10 and may be extended or contracted to move the movable contact member 50.

I-4. Fourth Modification

Any of the first, the second, the third, the fifth, the sixth, the seventh and the eighth embodiments described above may adopt the structure of the third vessel 34d of the fourth embodiment (FIG. 12A), in place of the structure of the third vessel 34 (for example, FIG. 4). In other words, the third vessel 34d including the separate lower vessel member 340 and cover vessel member 360 may be adopted for any of the first, the second, the third, the fifth and the sixth embodiments. Any of the first, the second, the third, the fifth, the sixth, the seventh and the eighth embodiments described above may adopt the structure of the joint member 30d of the fourth embodiment (FIG. 12A), in place of the structure of the joint member 30 (for example, FIG. 4). In other words, the joint member 30d including the first joint member 301 and the second joint members 303 of different materials may be adopted any of the first, the second, the third, the fifth, the sixth, the seventh and the eighth embodiments.

I-5. Other Modifications

I-5-1. Modification of First Spring and Relevant Parts

According to the above embodiment, the first spring 62 has the other end fixed to the third vessel 34 and is not displaced with the movement of the rod 60 (FIG. 4). The first spring 62 is, however, not restricted to the structure of the above embodiment but may be structured to be displaced with the movement of the rod 60 or may have another modified structure. The following describes a specific example. Although the modified structure of the first spring and the relevant parts is described below as a modification of the relay 5d of the fourth embodiment, this structure may be applied to the other embodiments.

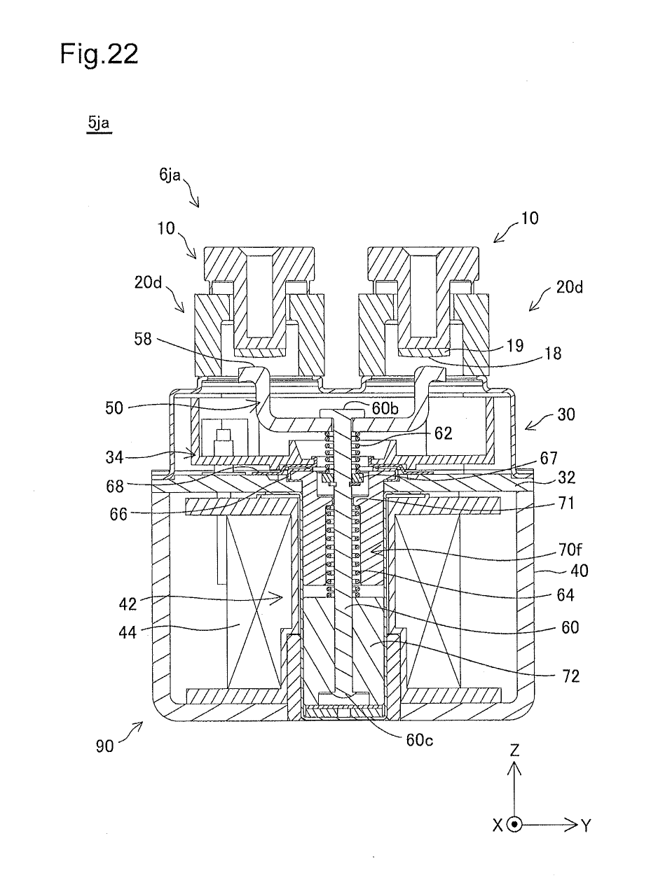

FIG. 22 is a diagram illustrating a relay 5ja according to Modification A. FIG. 22 is a diagram equivalent to the 6-6 cross sectional view of FIG. 12A. The difference from the fourth embodiment is mainly the structure that is in contact with the other end of the first spring 62. The like parts to those of the relay 5d of the fourth embodiment (FIG. 12A) are expressed by the like numerals or symbols and are not specifically described here.

As shown in FIG. 22, the first spring 62 has one end that is in contact with the movable contact member 50 and the other end that is in contact with a base seat 67. The base seat 67 is formed in circular shape. The base seat 67 is in contact with a C ring 61 fixed to the rod 60 and is thereby set at the fixed position relative to the rod 60. The base seat 67 is displaced with the movement of the rod 60. In other words, the first spring 62 is displaced with the movement of the rod 60. A cylindrical fixed iron core 70f has a projection 71 protruded inward. One end of the second spring 64 is in contact with the projection 71. Like the above embodiment, coil springs are used for the first spring 62 and the second spring 64. More specifically, helical compression springs are adopted like the above embodiment.

The relay 5ja of this structure operates in the following manner. As the coil 44 is energized, the movable iron core 72 moves closer to the fixed iron core 70f against the pressing force of the second spring 64 and comes into contact with the fixed iron core 70f. As the movable iron core 72 moves upward (direction closer to the fixed contacts 18), the rod 60 and the movable contact member 50 also move upward. This brings the movable contacts 58 into contact with the fixed contacts 18. In the state that the movable contacts 58 are in contact with the fixed contacts 18, the first spring 62 presses the movable contact member 50 toward the fixed contacts 18 to stably maintain contact between the fixed contacts 18 and the movable contacts 58.

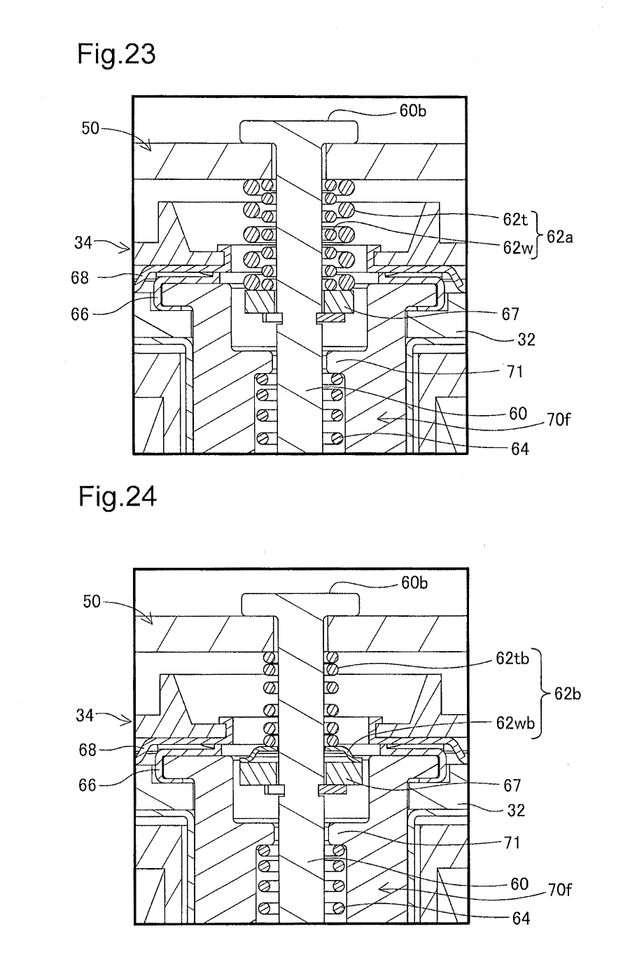

FIG. 23 is a diagram illustrating a first variation of Modification A. FIG. 23 is a view equivalent to the 6-6 cross sectional view of FIG. 12A and shows the periphery of a first spring member 62a. The difference between Modification A and the first variation shown in FIG. 23 is the structure of the first spring member 62a as the elastic member. The other structure is similar to that of Modification A. The like parts to those of the relay 5ja of Modification A are expressed by the like numerals or symbols and are not specifically described here. As shown in FIG. 23, the first spring member 62a includes an outer spring 62t and an inner spring 62w. Both the outer spring 62t and the inner spring 62w are coil springs. More specifically, both the outer spring 62t and the inner spring 62w are helical compression springs. The inner spring 62w is located inside the outer spring 62t. The inner spring 62w has a larger spring constant than the outer spring 62t. As described above, any of the relays 5 to 5i of the above embodiments may be structured to have a plurality of springs of different spring constants arranged in parallel as the elastic member that presses the movable contact member 50, 50c, or 50b against the fixed contacts 18. In the structure that a plurality of coil springs are arranged in parallel in the radial direction of the springs, it is preferable that the winding directions of the adjacent springs are reverse to each other. This arrangement advantageously reduces the possibility that the adjacent springs are tangled with each other even after repeated extension and contraction of the springs. For example, in the variation of Modification A, the inner spring 62w may be right-handed, while the outer spring 62t may be left-handed. This arrangement reduces the possibility that the coil wind of the inner spring 62w intervenes between the coil winds of the outer spring 62t.

FIG. 24 is a diagram illustrating a second variation of Modification A. FIG. 24 is a cross sectional view equivalent to the 6-6 cross sectional view of FIG. 12A and shows the periphery of a first spring member 62b. The difference between Modification A and the second variation shown in FIG. 24 is the structure of the first spring member 62b as the elastic member. The other structure is similar to that of Modification A. The like parts to those of the relay 5ja of Modification A are expressed by the like numerals or symbols and are not specifically described here. As shown in FIG. 24, the first spring member 62b includes a disc spring 62wb and a helical compression spring 62tb. More specifically, the disc spring 62wb and the helical compression spring 62tb are arranged in series. The disc spring 62wb and the helical compression spring 62tb have different spring constants. As described above, any of the relays 5 to 5i of the above embodiments may be structured to have a plurality of springs of different spring constants arranged in series as the elastic member that presses the movable contact member 50, 50a or 50b against the fixed contacts 18.

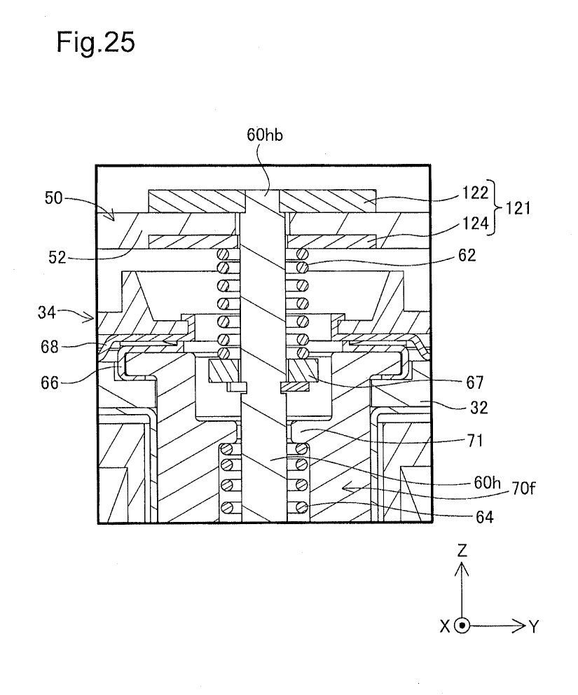

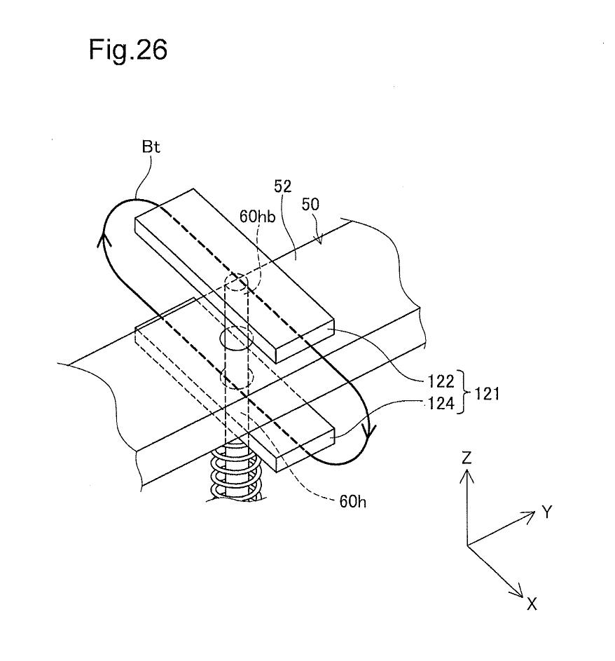

FIG. 25 is a first diagram illustrating a third variation of Modification A. FIG. 25 is a second diagram illustrating the third variation. FIG. 25 is a cross sectional view equivalent to the 6-6 cross sectional view of FIG. 12A and shows the periphery of the first spring 62. FIG. 26 is a diagram illustrating an auxiliary member 121. The differences between Modification A and the third variation include the structure of a movable contact member 60h and the addition of the auxiliary member 121. The other structure is similar to that of Modification A. The like parts to those of the relay 5ja of Modification A are expressed by the like numerals or symbols and are not specifically described here. The auxiliary member 121 generates a force in a direction that moves the movable contact member 50 closer to the fixed contacts 18 when the movable contacts 58 come into contact with the fixed contacts 18 and the electric current flows through the movable contact member 50. The following describes the third variation in more detail.

As shown in FIGS. 25 and 26, the auxiliary member 121 includes a first member 122 and a second member 124. The first member 122 and the second member 124 are both magnetic bodies. The first member 122 and the second member 124 are arranged across both sides of the movable contact member 50 (more specifically, its center section 52) in the moving direction of the movable contact member 50 (Z-axis direction). More specifically, the first member 122 is attached to one end portion 60hb of the rod 60h to be located on the side closer to the fixed contact 18 in the center section 52 of the movable contact member 50. The second member 124 is attached to the opposite side to the side of the first member 122 in the center section 52. As the electric current flows through the movable contact member 50, a magnetic field is generated in the periphery of the movable contact member 50. The generation of the magnetic field forms a magnetic flux Bt that passes through the first member 122 and the second member 124 (FIG. 26). The formation of the magnetic flux Bt produces attraction force (also called “magnetic adsorption”) between the first member 122 and the second member 124. In other words, the attraction force of moving the second member 124 closer to the first member 122 acts on the second member 124. This attraction force causes the second member 124 to apply the force to the movable contact member 50 and press the movable contact member 50 against the fixed contacts 18. This stably maintains contact between the movable contacts 58 and the fixed contacts 18 opposed to each other. The structure of producing the magnetic adsorption is not restricted to the shape of the first member 122 and the second member 124 described above. For example, any of various structures described in JP 2011-23332A may be used for the structure of the first member 122 and the second member 124.

I-5-2. Modification of Joint Member and Relevant Parts

The following describes a modification of the joint member and the relative parts. Although the modified structure of the joint member and the relevant parts is described below as a modification of the relay 5d of the fourth embodiment, this structure may be applied to the other embodiments.

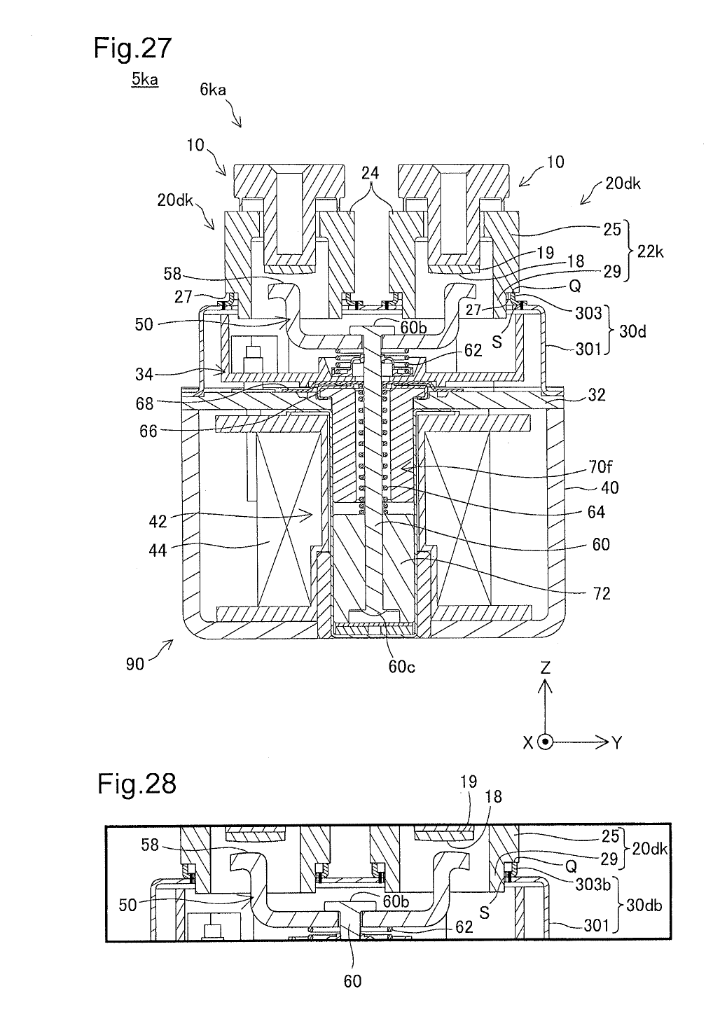

FIG. 27 is a diagram illustrating a relay 5ka according to Modification B. FIG. 27 is a diagram equivalent to the 6-6 cross sectional view of FIG. 12A. The differences between the fourth embodiment and the relay 5ka of Modification B include the shape of side face members 22k of first vessels 20dk and the structure of a third vessel 34. The other structure is similar to that of the fourth embodiment. The like parts to those of the relay 5d of the fourth embodiment are expressed by the like numerals or symbols and are not specifically described here. The third vessel 34 is formed from a single member, like the third vessel 34 of the first embodiment.

The side face member 22k of the first vessel 20dk has a thick-wall section 25 extended from the bottom 24 and a thin-wall section 29 extended from the thick-wall section 25. The circumferential length of the outer surface of the thin-wall section 29 is smaller than the circumferential length of the outer surface of the thick-wall section 25. A step 27 as part of the outer peripheral surface of the first vessel 20dk is formed on the boundary between the thin-wall section 29 and the thick-wall section 25. A joint member 30d is air-tightly joined with the step 27 by brazing. A joint area Q where the joint member 30d is joined with the first vessel 20dk is accordingly located across the first vessel 20dk from the fixed contact 18 and the movable contact 58. In other words, the joint area Q is at the position hidden (unviewable) from the fixed contact 18 and the movable contact 58 by the first vessel 20dk. A welded part S that is the joint part of the first joint member 301 with the second joint member 303 is also at the position hidden (unviewable) from the fixed contact 18 and the movable contact 58 by the first vessel 20dk.

As described above, the joint area Q is located across the first vessel 20dk from both the fixed contact 18 and the movable contact 58. This arrangement reduces the possibility that an arc generated between the fixed contact 18 and the movable contact 58 comes into contact with the joint area Q. This accordingly reduces the possibility that the joint area Q as the brazing part is damaged and thereby improves the durability of the relay 5.

FIG. 28 is a diagram illustrating a first variation of Modification B. The difference from Modification B is only the shape of a second joint member 303b of a joint member 30db. In Modification B, the joint part of the second joint member 303 with the first joint member 301 is bent in the direction away from the first vessel 20dk (FIG. 27). As shown in the first variation, however, the joint part of the second joint member 303b with the first joint member 301 may be bent in the direction closer to the first vessel 20.

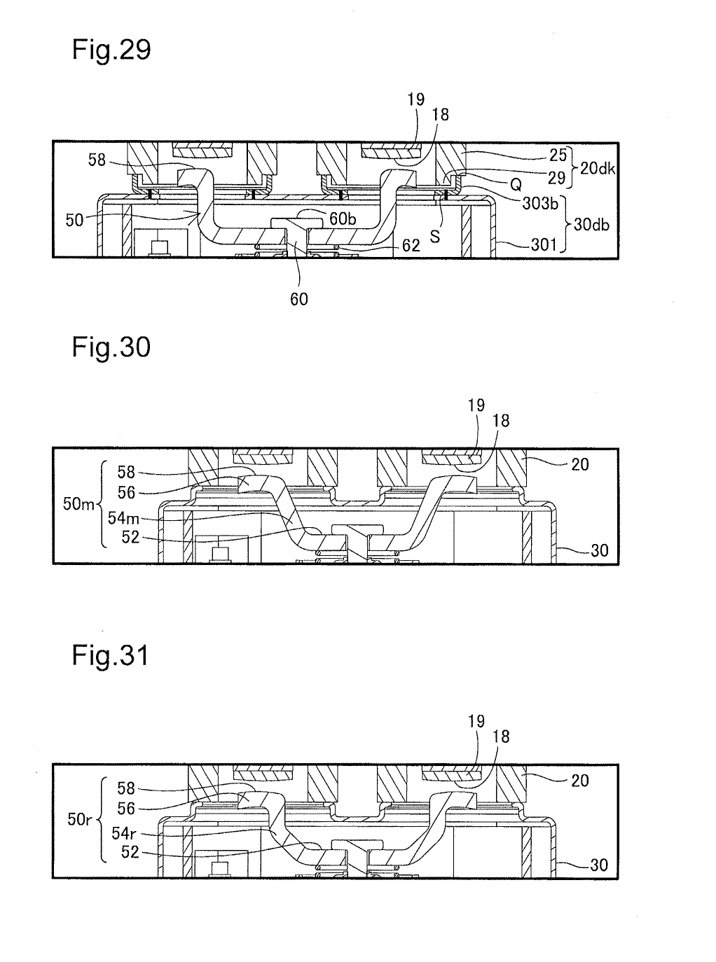

FIG. 29 is a diagram illustrating a second variation of Modification B. The difference from the first variation is the positional relationship between the thin-wall section 29 and the welded part S. As shown in the second variation, the welded part S may be located at the position exposed on the fixed contact 18 and the movable contact 58 across the thin-wall section 29.

I-6. Sixth Modification

According to the seventh embodiment described above, the partition wall member 21 is extended from the bottom 24 to the position further away from the bottom 24 than the position where the pair of movable contacts 58 are located with respect to the moving direction of the movable contact member 50 (FIG. 18). This arrangement is, however, not restrictive. The partition wall member 21 may be extended from the bottom 24 to the position further away from the bottom 24 than at least the position where the pair of fixed contacts 18 are located. Even when electric arc scatters the particulates of the component part of the fixed terminal 10, such modification enables the partition wall member 21 of the first vessel 20h to work as the barrier and thereby reduces the possibility that the particulates are accumulated to establish electrical continuity between the fixed terminals 10.

I-7. Seventh Modification

The shape of the any of the movable contact members 50, 50a and 50b is not limited to the shapes described in the above embodiments. The movable contact member 50, 50a or 50b is preferably in bent shape for movement of the movable contact member 50, 50a or 50b. More specifically, it is preferable that the movable contact member 50 or 50b is formed in bent shape to have the center section 52 and the movable contacts 58 located closer to the fixed contacts 18 than the center section 52 with respect to the moving direction. According to the above embodiment, the extended sections 54 are extended in the direction parallel to the moving direction (Z-axis direction) or more specifically in the direction from the center section 52 toward the fixed contacts 18 (positive Z-axis direction) (FIG. 4). This is, however, not restrictive. The extended sections 54 may be extended from the center section 52, which the rod 60 is inserted through, in any direction including the positive Z-axis direction component. In other words, the extended sections 54 may be inclined to the moving direction. For example, for example, the extended sections 54 may be formed in a shape such as the extended sections 54m of the movable contact member 50m shown in FIG. 30 or the extended sections 54r of the movable contact member 50r shown in FIG. 31.

### REFERENCE SIGNS LIST

5 to 5ka: Relay
6 to 6ka: Relay main unit
10: Fixed terminal
10W: Positive fixed terminal
10X: Negative fixed terminal
18: Fixed contact
19: Fixed contact area
20, 20d, 20dk: First vessel
32: Base
34: Third vessel
34d: Third vessel
40: Coil case
42: Coil bobbin
42a: Bobbin body
44: Coil
50 to 50b: Movable contact member
52 to 52b: Center section
54, 54b: Extended section
56 to 56b: Movable contact area
58, 58b: Movable contact
62: First spring
64: Second spring
70: Fixed iron core
72: Movable iron core
90: Driving structure
92, 92d: Second vessel
100: Air-tight space
100d: Air-tight space
200: Arc
800, 800d, 800e, 800f, 800i: Permanent magnet
850: Magnetic shield
I: Electric current
F1: Lorentz force
RV: Moving contact area
RX: Center area
Fa: Predetermined face

1. A relay, comprising:
a pair of fixed terminals arranged to respectively have fixed contacts;
a movable contact member arranged to have a pair of movable contacts that are correspondingly opposed to the respective fixed contacts of the pair of fixed terminals;
a driving structure operated to move the movable contact member, such that the respective movable contacts come into contact with the corresponding fixed contacts; and
a magnet arranged to extinguish an arc generated between each pair of the fixed contact and the movable contact facing each other, wherein
the movable contact member has a center section located between the pair of movable contacts,
the magnet is placed on at least one of a first side and a second side that face each other across a predetermined face including the movable contact member and the pair of fixed terminals electrically connected by the movable contact member, and
the magnet is arranged to have a magnitude relation that a center area where the center section is located has a lower magnetic flux density than movable contact portions where the pair of movable contacts are located,
the relay further comprising:
a magnetic shield placed between the center section and the magnet.

2. The relay according to claim 1, wherein
the magnet placed on at least one of the first side and the second side is a single magnet.

3. The relay according to claim 1, wherein
the movable contact member has a pair of extended sections that are located between the center section and the pair of movable contacts and are extended in a direction including a moving direction component of the movable contact member.

4. The relay according to claim 3, wherein
in vertical projection of the relay onto a projection face that is parallel to the predetermined face, the pair of movable contacts are located at positions that are overlapped with the magnet, and at least part of the center section is located at a position that is not overlapped with the magnet.

5. The relay according to claim 3, wherein
the movable contact member also has a pair of movable contact portions that are extended from the pair of extended sections to be closer to each other.

6. (canceled)

7. The relay according to claim 1, further comprising:
a vessel configured to internally form an internal space and arranged to place the movable contact member and the respective fixed terminals therein, wherein
the vessel comprises:
one first vessel arranged to have insulating property and structured to have a bottom and two chambers formed as part of the internal space corresponding to the pair of fixed terminals, wherein the pair of fixed terminals pass through the bottom of the first vessel and are attached to the first vessel, such that the pair of fixed contacts of the fixed terminals are placed inside of the first vessel and portions of remaining parts of the fixed terminals are placed outside of the first vessel; and
a second vessel joined with the first vessel to form, in combination with the respective fixed terminals and the first vessel, the internal space, wherein
the first vessel has a partition wall member that is extended from the bottom to a position further away from the bottom than at least a position where the respective fixed contacts are located with respect to a moving direction of the movable contact member, the partition wall member parting the two chambers from each other, and
the respective fixed contacts are placed inside the respective chambers in the internal space.

8. The relay according to claim 7, wherein
the partition wall member is extended from the bottom to a position further away from the bottom than at least a position where the respective movable contacts are located, with respect to the moving direction of the movable contact member, and
the respective movable contacts are placed inside the respective chambers in the internal space.

9. A relay, comprising:
a pair of fixed terminals arranged to respectively have fixed contacts;
a movable contact member arranged to have a pair of movable contacts that are correspondingly opposed to the respective fixed contacts of the pair of fixed terminals;
a driving structure operated to move the movable contact member, such that the respective movable contacts come into contact with the corresponding fixed contacts;
a magnet arranged to extinguish an arc generated between each pair of the fixed contact and the movable contact facing each other; and
a vessel configured to internally form an internal space and arranged to place the movable contact member and the fixed contacts therein, wherein
the movable contact member has a center section located between the pair of movable contacts,
the magnet is placed on at least one of a first side and a second side that face each other across a predetermined face including the movable contact member and the pair of fixed terminals electrically connected by the movable contact member,
the magnet is arranged to have a magnitude relation that a center area where the center section is located has a lower magnetic flux density than movable contact portions where the pair of movable contacts are located, and
the vessel comprises:
two first vessels provided corresponding to the respective fixed terminals and arranged to place the respective fixed contacts therein; and
a second vessel joined with the two first vessels to form, in combination with the respective fixed terminals and the respective first vessels, the internal space.

10. The relay according to claim 9, wherein
the respective movable contacts are placed inside the respective first vessels in the internal space.

11. The relay according to claim 1, wherein
the magnet is placed on both the first side and second side.

12. A relay, comprising:
a pair of fixed terminals arranged to respectively have fixed contacts;
a movable contact member arranged to have a pair of movable contacts that are correspondingly opposed to the respective fixed contacts of the pair of fixed terminals;
a driving structure operated to move the movable contact member, such that the respective movable contacts come into contact with the corresponding fixed contacts; and
a magnet arranged to extinguish an arc generated between each pair of the fixed contact and the movable contact facing each other,
the relay being applied to a system including a power source and a load, wherein
the magnet is placed on at least one of a first side and a second side that face each other across a predetermined face including the movable contact member and the pair of fixed terminals electrically connected by the movable contact member and is arranged to apply Lorentz force to electric current flowing through the movable contact member in a direction of moving the movable contact member closer to the opposed fixed contacts, when electric current flows in the relay during supply of electric power from the power source to the load.

13. A relay, comprising:
a pair of fixed terminals arranged to respectively have fixed contacts;
a movable contact member arranged to have a pair of movable contacts that are correspondingly opposed to the respective fixed contacts of the pair of fixed terminals;
a driving structure operated to move the movable contact member, such that the respective movable contacts come into contact with the corresponding fixed contacts; and
a magnet arranged to extinguish an arc generated between each pair of the fixed contact and the movable contact facing each other, wherein
the movable contact member has a center section located between the pair of movable contacts,
the magnet is placed on at least one of a first side and a second side across a predetermined face including the movable contact member and the pair of fixed terminals electrically connected by the movable contact member,
the magnet is arranged to have a magnitude relation that a center area where the center section is located has a lower magnetic flux density than movable contact areas where the pair of movable contacts are located, and
the magnet placed on at least one of the first side and the second side is a single magnet.

14. A relay, comprising:
a pair of fixed terminals arranged to respectively have fixed contacts;
a movable contact member arranged to have a pair of movable contacts that are correspondingly opposed to the respective fixed contacts of the pair of fixed terminals;
a driving structure operated to move the movable contact member, such that the respective movable contacts come into contact with the corresponding fixed contacts; and
a magnet arranged to extinguish an arc generated between each pair of the fixed contact and the movable contact facing each other, wherein
the movable contact member has a center section located between the pair of movable contacts,
the magnet is placed on at least one of a first side and a second side across a predetermined face including the movable contact member and the pair of fixed terminals electrically connected by the movable contact member,
the magnet is arranged to have a magnitude relation that a center area where the center section is located has a lower magnetic flux density than movable contact areas where the pair of movable contacts are located, and
the movable contact member has a pair of extended sections that are located between the center section and the pair of movable contacts and are extended in a direction including a moving direction component of the movable contact member.
